(19) United States
(12) Patent Application Publication
(10) Pub. No.: US 2022/0277579 A1
(43) Pub. Date: Sep. 1, 2022

(54) CLUSTERED DYNAMIC GRAPH CONVOLUTIONAL NEURAL NETWORK (CNN) FOR BIOMETRIC THREE-DIMENSIONAL (3D) HAND RECOGNITION

(71) Applicants: Jan Svoboda, Lugano (CH); Pietro Astolfi, Lugano (CH); Davide Boscaini, Lugano (CH); Jonatan Masci, Lugano (CH); Nnaisense SA, Lugano (CH)

(72) Inventors: Jan Svoboda, Lugano (CH); Pietro Astolfi, Trento (IT); Davide Boscaini, Verona (IT); Jonatan Masci, Lugano (CH)

(21) Appl. No.: 17/675,011

(22) Filed: Feb. 18, 2022

Related U.S. Application Data
(60) Provisional application No. 63/151,143, filed on Feb. 19, 2021.

(51) Int. Cl. G06V 40/10; G06V 10/82; G06V 10/762; G06V 10/774; G06V 10/46; G06V 10/74; G06F 21/32

(52) U.S. Cl. CPC G06V 40/11; G06V 10/82; G06V 10/763; G06V 10/7635; G06V 10/774; G06V 10/46; G06V 10/761; G06F 21/32

(57) ABSTRACT

A computer-implemented method of characterizing a person's hand geometry includes inputting a three-dimensional (3D) point cloud of the person's hand into a clustered dynamic graph convolutional neural network (clustered DGCNN), and processing the 3D point cloud, with a shared network portion of the clustered DGCNN, to create a processed version of the three-dimensional point cloud. The method further includes, with a shape regression network portion of the clustered DGCNN, assigning each respective feature point in the processed version of the 3D point cloud to a corresponding one of a plurality of pre-defined clusters, and applying one or more transformations to the feature points assigned to each respective cluster to produce per cluster shape parameters that represent shapes associated with portions of the person's hand that correspond to associated ones of the pre-defined clusters. Each pre-defined cluster corresponds to a unique part of a hand's surface.

### CROSS-REFERENCE TO RELATED APPLICATION(S)

This application claims the benefit of priority to U.S. Provisional Patent Application No. 63/151,143, entitled CLUSTERED DYNAMIC GRAPH CONVOLUTIONAL NEURAL NETWORK (CNN) FOR BIOMETRIC THREE-DIMENSIONAL (3D) HAND RECOGNITION, which was filed on Feb. 19, 2021. The disclosure of the prior application is incorporated by reference herein in its entirety.

### FIELD OF THE INVENTION

This disclosure relates to three-dimensional (3D) hand shape recognition and, more particularly, relates to three-dimensional (3D) hand recognition using a clustered dynamic graph convolutional neural network (CNN).

### BACKGROUND

Research in biometric recognition using hand shape has been somewhat stagnating in the last decade. Meanwhile, computer vision and machine learning have experienced a paradigm shift with a renaissance of deep learning, which has set a new state-of-the-art in many related fields. Improvements in biometric three-dimensional hand shape recognition are desirable.

### SUMMARY OF THE INVENTION

In one aspect, a computer-implemented method of characterizing a person's hand geometry includes inputting a three-dimensional (3D) point cloud of the person's hand into a clustered dynamic graph convolutional neural network (clustered DGCNN), and processing the 3D point cloud, with a shared network portion of the clustered DGCNN, to create a processed version of the three-dimensional point cloud. The method further includes, with a shape regression network portion of the clustered DGCNN, assigning each respective feature point in the processed version of the 3D point cloud to a corresponding one of a plurality of pre-defined clusters, and applying one or more transformations to the feature points assigned to each respective cluster to produce per cluster shape parameters that represent shapes associated with portions of the person's hand that correspond to associated ones of the pre-defined clusters. Each pre-defined cluster corresponds to a unique part of a hand's surface.

In another aspect, a computer system for characterizing a visual appearance of a person's hand includes a computer processor and computer-based memory operatively coupled to the computer processor, wherein the computer-based memory stores computer-readable instructions that, when executed by the computer processor, cause the computer-based system to perform certain functions. In a typical implementation, the functions include inputting a three-dimensional (3D) point cloud of the person's hand into a clustered dynamic graph convolutional neural network (clustered DGCNN), and processing the 3D point cloud, with a shared network portion of the clustered DGCNN, to create a processed version of the three-dimensional point cloud. The method further includes, with a shape regression network portion of the clustered DGCNN, assigning each respective feature point in the processed version of the 3D point cloud to a corresponding one of a plurality of pre-defined clusters, and applying one or more transformations to the feature points assigned to each respective cluster to produce per cluster shape parameters that represent shapes associated with portions of the person's hand that correspond to associated ones of the pre-defined clusters. Each pre-defined cluster corresponds to a unique part of a hand's surface.

In yet another aspect, a non-transitory computer readable medium having stored thereon computer-readable instructions that, when executed by a computer-based processor, cause the computer-based processor to input a three-dimensional point cloud of the person's hand into a clustered dynamic graph convolutional neural network (clustered DGCNN), and process the three-dimensional point cloud, with a shared network portion of the clustered DGCNN that comprises one or more convolutional layers, to create a processed version of the three-dimensional point cloud. Also, with a shape regression network portion of the clustered DGCNN, the computer processor assigns each respective feature point in the processed version of the three-dimensional point cloud to a corresponding one of a plurality of pre-defined clusters, wherein each pre-defined cluster corresponds to a unique part of a hand's surface, and applies one or more transformations to the feature points assigned to each respective cluster to produce per cluster shape parameters that represent shapes associated with portions of the person's hand that correspond to associated ones of the pre-defined clusters.

In still another aspect, a computer-implemented method of authenticating a person's identity includes capturing a three-dimensional point cloud of the person's hand with a three-dimensional scanner and inputting the three-dimensional point cloud to a clustered dynamic graph convolutional neural network (clustered DGCNN) and generating shape parameters from the three-dimensional point cloud with the clustered DGCNN. The shape parameters describe (represent) each respective portion of the person's hand that corresponds with an associated one of a plurality of predefined clusters. The predefined clusters correspond to unique parts of a (generic) hand's surface. The method further includes computing a similarity score by comparing the generated shape parameters associated with the person's hand to a corresponding set of shape parameters associated with an earlier scanned hand on a cluster-by-cluster basis and determining whether the person's hand matches the earlier scanned hand based on whether the similarity score meets or exceeds a threshold value.

In another aspect, a computer system includes a computer processor and computer-based memory operatively coupled to the computer processor. The computer-based memory stores computer-readable instructions that, when executed by the computer processor, cause the computer-based system to: capture a three-dimensional point cloud of the person's hand with a three-dimensional scanner and inputting the three-dimensional point cloud to a clustered dynamic graph convolutional neural network (clustered DGCNN), and generate shape parameters from the three-dimensional point cloud with the clustered DGCNN. The shape parameters describe each respective portion of the person's hand that corresponds with an associated one of a plurality of predefined clusters. The predefined clusters correspond to unique parts of a hand's surface. The processor further computes a similarity score by comparing the generated shape parameters associated with the person's hand to a corresponding set of shape parameters associated with an earlier scanned hand on a cluster-by-cluster basis and determines whether the person's hand matches the earlier scanned hand based on whether the similarity score meets or exceeds a threshold value.

In yet another aspect, a non-transitory computer readable medium having stored thereon computer-readable instructions that, when executed by a computer-based processor, cause the computer-based processor to: capture a three-dimensional point cloud of the person's hand with a three-dimensional scanner and inputting the three-dimensional point cloud to a clustered dynamic graph convolutional neural network (clustered DGCNN), and generate shape parameters from the three-dimensional point cloud with the clustered DGCNN. The shape parameters describe each respective portion of the person's hand that corresponds with an associated one of a plurality of predefined clusters. The predefined clusters correspond to unique parts of a hand's surface. The processor further computes a similarity score by comparing the generated shape parameters associated with the person's hand to a corresponding set of shape parameters associated with an earlier scanned hand on a cluster-by-cluster basis and determines whether the person's hand matches the earlier scanned hand based on whether the similarity score meets or exceeds a threshold value.

In still another aspect, a computer-implemented method of training a neural network to characterizing a geometry of a person's hand includes generating a synthetic dataset of hand images using a computer-implemented hand model generator with shape and/or pose parameters as inputs to the model, and training a clustered dynamic graph convolutional neural network (clustered DGCNN), in a supervised learning context, using the generated synthetic hand images as inputs and the shape and/or pose parameters as labels for the inputs.

In a typical implementation, the DGCNN includes a shared network portion that comprises one or more convolutional layers in series with one another, a pose regression network portion that comprises a clustered pooling layer and one or more fully connected layers in series with one another, and a shape regression network portion that comprises a clustered pooling layer and one or more fully connected layers connected in series with one another. The clustered DGCNN may be configured such that the shared network portion produces an output that is fed into the pose regression network portion of the clustered DGCNN and the shape regression network portion of the clustered DGCNN.

In some implementations, one or more of the following advantages are present.

For example, in some implementations, the systems and techniques disclosed herein

In a typical implementation, the systems and techniques disclosed herein provide a method of characterizing geometry of a person's hand. This can be applied to a wide variety of possible applications, including, for example, identifying and/or distinguishing people based on the shape of his or her hand. The systems and techniques disclosed here, in a typical implementation, are easy to use, easy to integrate, to some extent invariant to age, work with dirty hands, work with thin gloves covering the hands, etc. The systems and techniques disclosed herein may be particularly helpful in environments where people are wearing gloves, masks, goggles, other face coverings, etc. that may make fingerprint, palmprint, or face recognition technologies difficult or impractical. Limitations of face recognition technologies has clearly become a big issue today in the past few years with the prevalence of mask-wearing due to the Covid-19 pandemic. Additionally, the systems and techniques disclosed herein may be advantageous in places, such as laboratories or hospitals, where taking off hand/face protection is not always easy, and/or in countries where people have to wear face covers— e.g., some middle east cultures. Other situations where the systems and/or techniques disclosed herein may be of interest would be where face-recognition restrictions or regulations apply.

The systems and techniques disclosed herein can generally be implemented utilizing affordable, widespread, small form factor, off-the-shelf 3D cameras, for example. Additionally, the systems and techniques disclosed herein performs well despite noise in the data and heavy non-rigidity of the human hand.

Additionally, the use of synthetic training data, as described herein, presents the opportunity for virtually unlimited training data. This avoids the necessity of having a big training data set of real hand images, which can be difficult to assemble in view of privacy concerns and other challenges.

Other features and advantages will be apparent from the description and drawings, and from the claims.

### BRIEF DESCRIPTION OF THE DRAWINGS

FIG. 1 is a flowchart representing one implementation of a process that includes setting up, training, and utilizing a system, which includes a particular type of artificial neural network (referred to herein as a clustered dynamic graph convolutional neural network (or “Clustered DGCNN”)), for recognizing and/or assessing an authorization request by a human user, for example, based on the user's biometric data.

FIG. 2 is a schematic representation showing one implementation of a system, that includes a computer, which may be assembled as part of the FIG. 1 process.

FIG. 3 is a schematic representation of an implementation of a clustered dynamic graph convolutional neural network (DGCNN) that may be deployed, for example, on the computer of FIG. 2 for use in connection with 3D hand shape recognition.

FIG. 4 is a schematic representation showing qualitative differences between global pooling and clustered pooling.

FIG. 5 is a schematic representation of an example of a dynamic edge convolutional layer.

FIG. 6 is a schematic representation of an example of a clustered pooling layer.

FIG. 7 is a schematic representation of an example of a global pooling (GP) layer.

FIG. 8 is a schematic representation of an example of a fully connected (FC) layer.

FIG. 9 is a schematic representation of an example of a comparison of shape parameters, on a cluster-by-cluster basis, from two hand scans.

FIG. 10 is a table presenting matching performance of presented methods on different datasets in terms of Top-1 accuracy and EER.

FIG. 11 includes graphs that plot True Accept Rate versus False Reject Rate for various approaches and with different data sources.

FIG. 12 depicts exemplary recorded video sequences of a hand.

FIG. 13 is a schematic representation of exemplary preprocessing steps for dataset samples.

FIG. 14 shows exemplary original point clouds and results of clustering.

Like reference characters refer to like elements.

### DETAILED DESCRIPTION

This document uses a variety of terminology to describe the inventive concepts set forth herein. Unless otherwise indicated, the following terminology, and variations thereof, should be understood as having their ordinary meanings and/or meanings that are consistent with what follows.

“Biometric data” refers to anything that relates to the measurement of people's physical features and characteristics. One example of biometric data is hand geometry, which may include, for example, data describing the shape of a person's hand and/or data describing a pose of the person's hand. Biometric authentication, for example, may be used in as a form of identification and/or access control.

A “point cloud” is a digital representation of a set of data points in space. The data points may represent a 3D shape or object, such as a hand. Each point position within the point cloud may have a set of Cartesian coordinates (e.g., X, Y, and Z), for example. Point clouds may be produced, for example, by a 3D scanners or by photogrammetry software. In one exemplary implementation, a point cloud representation may be an RGB-D scan.

An “RGB-D scan” (or “RGB-D image”) is a digital representation of an image of an object (e.g., a human hand) that includes both color information and depth information about the object. In some instances, each pixel in an RGB-D scan may include information about the object's color (e.g., in a red, green, blue color scheme) and depth (e.g., a distance between an image plane of the RGB-D scanner and the corresponding object in the image).

“Pose parameters” refers to a collection of digital data that represents a pose of a hand represented in a point cloud of the hand.

“Shape parameters” refers to a collection of digital data that represents a shape of a hand represented in a point cloud of the hand.

A “multilayered perceptron” (or “MLP”) is a type of artificial neural network (“ANN”), More specifically, in a typical implementation, the phrase “multilayer layered perceptron” refers to a class of feedforward ANNs. An MLP generally has at least three layers of nodes: an input layer, a hidden layer, and an output layer. In a typical implementation, except for any input nodes, each node is a neuron that uses a nonlinear activation function. MLPs may utilize supervised learning (backpropagation) for training.

A “fully connected layer” (or “FC layer”) refers to a layer in an artificial neural network that connects every neuron in one layer to every neuron in another layer. More specifically, in a typical implementation, fully connected layers are those layers where all the inputs from one layer are connected to every activation unit of the next layer. Fully connected layers may help, for example, to compile data extracted by previous layers to form a final output.

A “rectifier” or “rectified linear unit” or “ReLU” refers to a function that can be utilized as an activation function in an artificial neural network. The activation function may be defined, for example, as the positive part of its argument: f(x)=x⁺=max(0,x), where x is the input to a neuron in an artificial neural network.

“Hyperbolic tangent” or “TanH” refers to a function that can be utilized as an activation function in an artificial neural network. Hyperbolic functions are analogues of the ordinary trigonometric functions (e.g., tangent), but defined using a hyperbola, rather than a circle.

“Pooling,” in a typical implementation, refers to a form of non-linear sampling. A “pooling layer” is a layer in an artificial neural network, for example, which performs pooling. There are several non-linear functions that may be used to implement pooling, with max pooling being a common one.

“Cluster analysis” or “clustering” refers to a task performed by a neural network, for example, that groups sets of objects in such a way that objects in the same group (called a “cluster”) are more similar (in some sense) to each other than to those in other groups (clusters). A “clustering layer” is a layer in an artificial neural network, for example, which performs clustering.

An “RGB-D” image is a computer-representation of a combination of a RGB (red-green-blue) image and its corresponding depth image. A depth image is an image channel in which each pixel relates to a distance between an image plane and the corresponding object in the RGB image.

“Furthest Point Sampling,” in an exemplary implementation, refers to a computer-implemented algorithm that starts with a randomly selected vertex as the first source and iteratively selects farthest vertex from the already selected sources.

“iterative closest point” or “ICP,” in an exemplary implementation, refers to a computer-implemented algorithm that aligns two point clouds so that a specific distance measure between their points is minimal.

“K-nearest neighbors” refers to a computer-implemented algorithm used for classification and regression, where the input consists of the k closest training examples in an input data set. The output is a property value for the object, where the property value relates to a function applied to the values of the k (some positive number of) nearest neighbors.

An “affine transformation” is a computer-implemented algorithm that maps an affine space onto itself while preserving both the dimension of any affine subspaces and the ratios of the lengths of parallel line segments, for example.

A “synthetic” training dataset refers to a training dataset for a neural network that has been generated by a computer-implemented modeling system, such as the Mano (hand Model with Articulated and Non-rigid defOrmations), described, for example, in Romero, J., Tzionas, D., and Black, M. J. Embodied hands: Modeling and capturing hands and bodies together. Proc. SIGGRAPH Asia, 2017.) A “synthetic” training dataset does not include any images captured, by a camera or scanner, for example, captured from the real, non-virtual world.

A “three-dimensional” scanner (or camera) is any physical device that can produce or be used to produce a three-dimensional point cloud representation of a real-world object (e.g., a person's hand).

“Hand geometry” refers to overall shape and pose of a hand but does not typically include handprints or fingerprints.

Biometric systems can be used in a wide variety of different applications including, for example, access control, identification, verification, or the like. Biometric systems based on 3D hand geometry, as disclosed herein, provide an interesting alternative in places where fingerprints and palmprints cannot be used (e.g., where the person may be wearing latex gloves, or have very dirty hands) and face recognition is not an option either (e.g., where the person may be wearing a face mask, a helmets, goggles, or other protective equipment that covers at least a portion of the person's face). Solutions have been proposed in the past (See, e.g., Kanhangad, V., Kumar, A., and Zhang, D. Combining 2d and 3d hand geometry features for biometric verification. Proc. CVPR, 2009; Kanhangad, V., Kumar, A., and Zhang, D. Contactless and pose invariant biometric identification using hand surface. IEEE Transactions on Image Processing, 20(5):1415-1424, 2011; Wang, C., Liu, H., and Liu, X. Contact-free and pose invariant hand-biometric-based personal identification system using rgb and depth data. Journal of Zhejiang University SCIENCE C, 15:525-536, 2014a; and Svoboda, J., Bronstein, M. M., and Drahansky, M. Contactless biometric hand geometry recognition using a low-cost 3d camera. In Proc. ICB, 2015), however, they generally do not offer satisfactory performance neither are they easy to use as they often impose strong constraints on the acquisition environment. One could try to simply drop many of the acquisition constraints. Such a system, however, would require a new dataset, as evaluation data for such an approach are missing at the moment.

This document presents a novel approach to biometric hand shape recognition by utilizing some recently developed principles based on Dynamic Graph CNN (DGCNN) (see, e.g., Wang, Y., Sun, Y., Liu, Z., Sarma, S. E., Bronstein, M. M., and Solomon, J. M. Dynamic graph CNN for learning on point clouds. ACM Transactions on Graphics (TOG), 38 (5), 2019.). Taking into consideration that a hand is a rather complex geometric object, the systems and techniques disclosed herein, for example, replace the Global Pooling Layer with a so-called Clustered Pooling Layer, which allows having a piece-wise descriptor (per-cluster) of the hand, instead of creating just one global descriptor.

Successful training of geometric deep learning (GDL) models however requires noticeable amount of annotated data, which one typically does not have in biometrics. To overcome this limitation, the inventors created (and the systems and techniques disclosed herein involve creating) a synthetic dataset of hand point clouds using the MANO (Romero, J., Tzionas, D., and Black, M. J. Embodied hands: Modeling and capturing hands and bodies together. Proc. SIGGRAPH Asia, 2017.) model and show how to train the proposed model fully on synthetic data while achieving good results on real data during experiments.

Additionally, in order to evaluate the systems and techniques disclosed herein, a new dataset was generated for less constrained 3D hand biometric recognition. The dataset was acquired using a low cost acquisition device (an off-the-shelf RGB-D camera) in variable environmental conditions (e.g., there were no constraints on where the system was placed during acquisition). Each sample is a short RGB-D video of a user performing a predefined gesture, which allowed capture of frames in different poses and opens door to possibly new research areas (e.g., non-rigid hand shape recognition, hand shape recognition from a video sequence, etc.). To set a baseline performance, the novel dataset was evaluated on two state-of-the-art GDL models, namely the PointNet++ (see, e.g., Qi, C. R., Yi, L., Su, H., and Guibas, L. J. Pointnet++: Deep hierarchical feature learning on point sets in a metric space. Proc. NIPS, 2017.) and DGCNN (see, e.g., Wang, Y., Sun, Y., Liu, Z., Sarma, S. E., Bronstein, M. M., and Solomon, J. M. Dynamic graph CNN for learning on point clouds. ACM Transactions on Graphics (TOG), 38 (5), 2019.).

Some aspects of the current disclosure include, for example:
a Clustered DGCNN: A novel geometric deep learning architecture for 3D hand shape recognition based on the Dynamic Graph CNN.
A Transfer learning solution for training of 3D hand shape recognition models using a synthetically generated dataset of hands.
NNHand RGB-D: New biometric dataset of RGB-D video sequences for the purpose of 3D hand shape recognition.

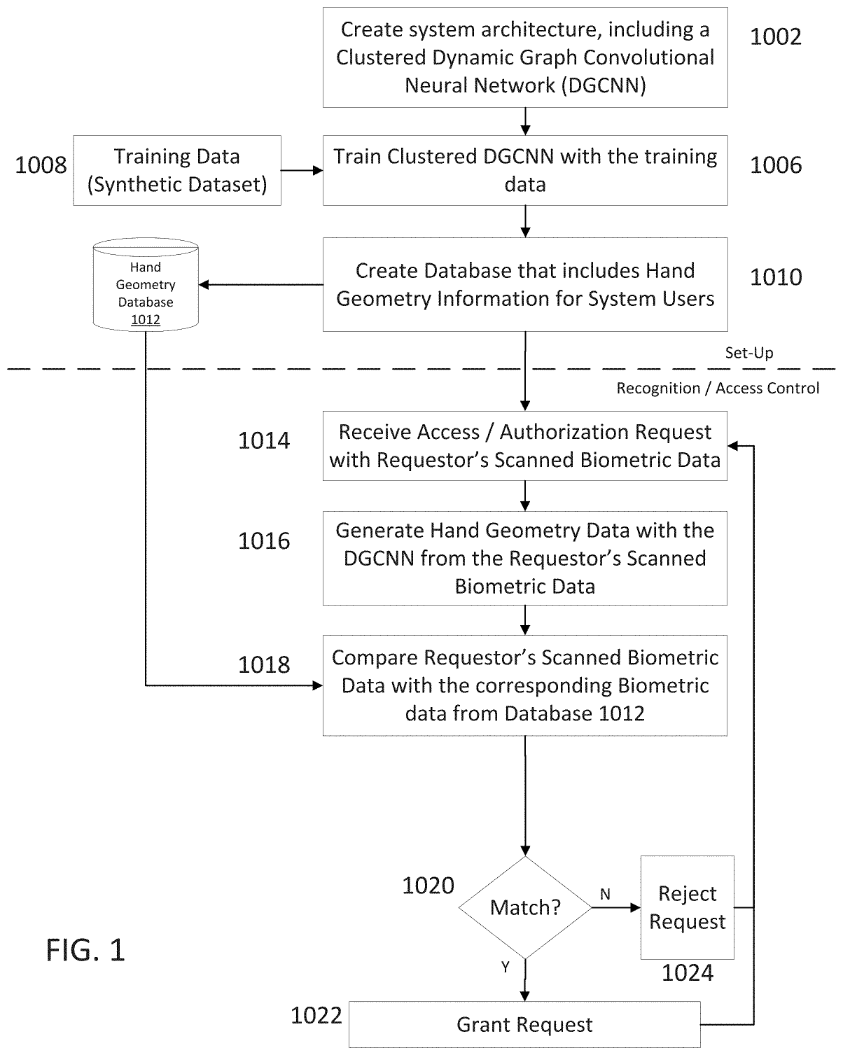

FIG. 1 is a flowchart representing one implementation of a process that includes setting up, training, and utilizing a system, that includes a particular type of artificial neural network (referred to herein as a clustered dynamic graph convolutional neural network (or “Clustered DGCNN”)), for use in recognizing and/or assessing an authorization request by a human user, for example, based on the user's biometric data.

The first step in the process represented by the illustrated flowchart (at 1002) is creating the system architecture, including the clustered DGCNN. This step can be implemented in a wide variety of ways and utilizing a wide variety of different types of components to create the system architecture.

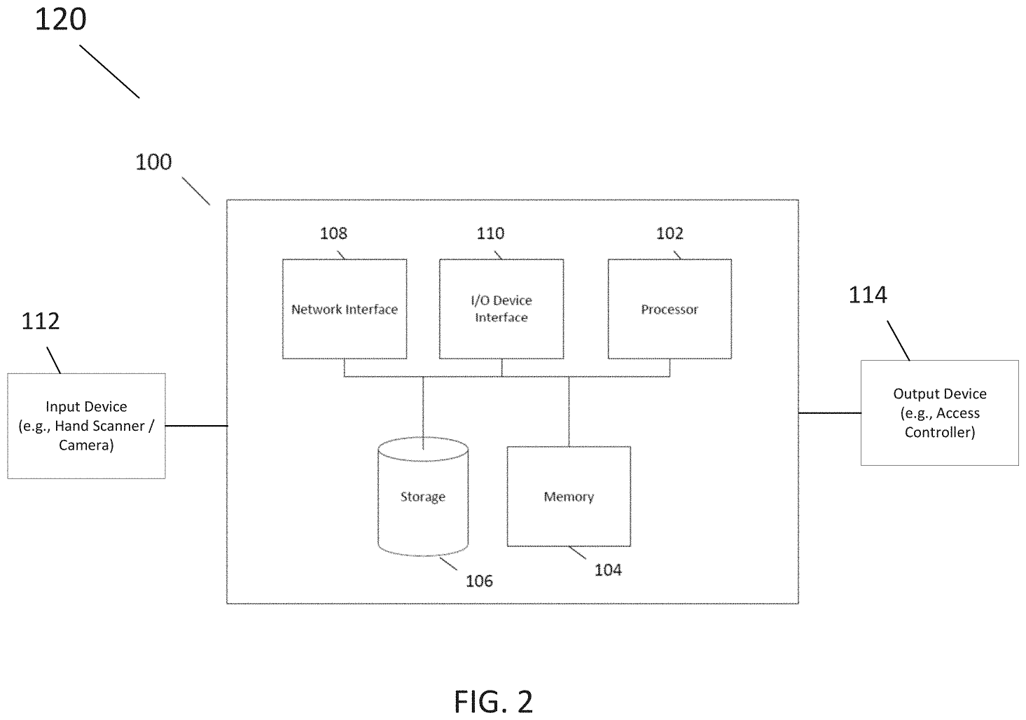

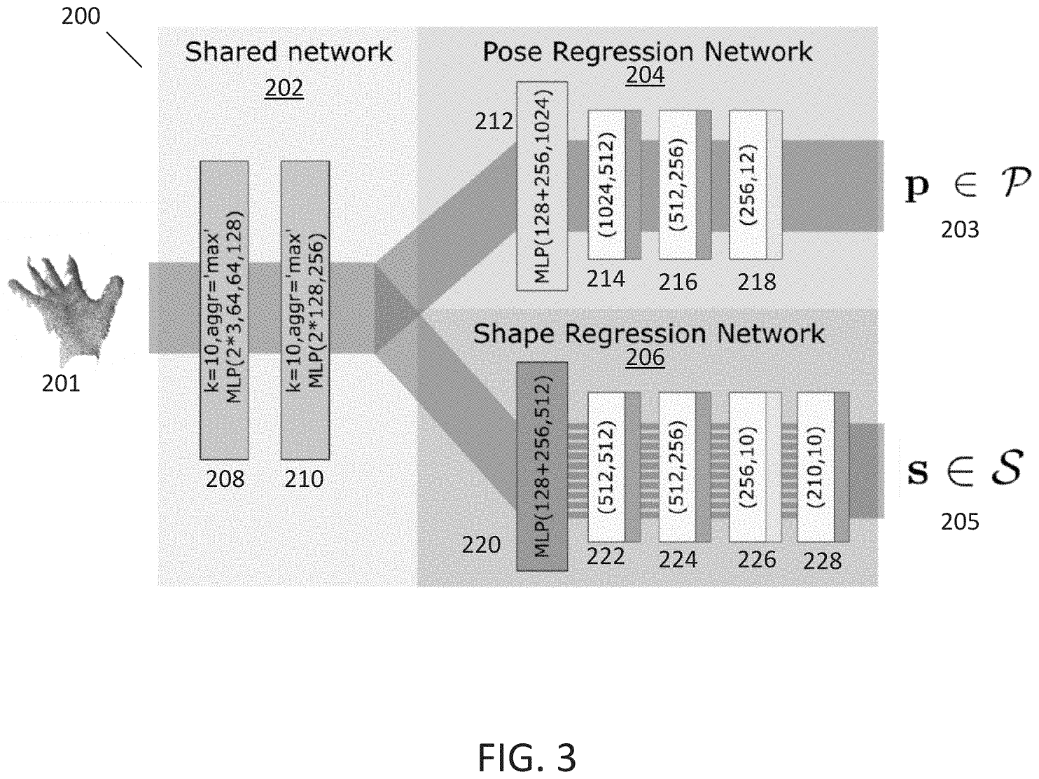

FIG. 2 is a schematic representation showing one implementation of a system 120, including various components thereof, that might be assembled as part of this first step (1002). The illustrated system 200 has an input device 112, a computer 100, and an output device 114. The input device 112 in the illustrated system 120 is configured to capture biometric data from a person seeking to be identified and/or authorized to access some physical or virtual environment or process, for example. The computer 100 in the illustrated system 120 is configured to host the clustered DGCNN (200 in FIG. 3) for assessing the captured biometric data and to either identify person seeking to be identified or make a determination on the person's authorization request. The output device 114 is configured to present an output based on the person's identification or to grant or deny the person's access request to the desired resource.

The input device 112 can be virtually any kind of device or component that is able to capture and/or provide a digital representation of the person's biometric data. For example, in some implementations, the input device 112 is configured to produce a 3D image of the person's hand (e.g., by scanning or photographing the hand) for processing by the computer 100. Examples of input devices 112 include CMOS cameras that utilize infrared light sources, computed tomography scanners, structured-light 3D scanners, LiDAR, and time of flight 3D scanners, etc. In a typical implementation, the data collected from the scanning process may be used to produce a 3D model of the scanned object (e.g., a human hand) representing hand geometry when it was scanned.

The computer 100 is configured to process the 3D image data provided from the input device 112 and to send a signal to the output device 114 (e.g., with an identity of the user, or with an access authorization or not).

The illustrated computer 100 has a processor 102, computer-based memory 104, computer-based storage 106, a network interface 108, an input/output device interface 110, and a bus that serves as an interconnect between the components of the computer 100. The bus acts as a communication medium over which the various components of the computer 100 can communicate and interact with one another.

The processor 102 is configured to perform the various computer-based functionalities disclosed herein as well as other supporting functionalities not explicitly disclosed herein. In certain implementations, some of the computer-based functionalities that the processor 102 performs include are those functionalities disclosed herein as being attributable to any one or more of components shown in FIG. 3 and more. Typically, the processor 102 performs these and other functionalities by executing computer-readable instructions stored on a computer-readable medium (e.g., memory 104 and/or storage 106). In various implementations, some of the processor functionalities may be performed with reference to data stored in one or more of these computer-readable media and/or received from some external source (e.g., from an I/O device through the I/O device interface 110 and/or from an external network via the network interface 108). The processor 102 in the illustrated implementation is represented as a single hardware component at a single node. In various implementations, however, the processor 102 may be distributed across multiple hardware components at different physical and network locations.

The computer 100 has both volatile and non-volatile memory/storage capabilities.

In the illustrated implementation, memory 104 provides volatile storage capability for computer-readable instructions that, when executed by the processor 102, cause the processor 102 to perform at least some of (or all) the computer-based functionalities disclosed herein. More specifically, in a typical implementation, memory 104 stores a computer software program that is able to process a 3D hand shape data in accordance with the systems and computer-based functionalities disclosed herein. In the illustrated implementation, memory 104 is represented as a single hardware component at a single node in one single computer 100. However, in various implementations, memory 104 may be distributed across multiple hardware components at different physical and network locations (e.g., in different computers).

In the illustrated implementation, storage 106 provides non-volatile memory for computer-readable instructions representing an operating system, configuration information, etc. to support the systems and computer-based functionalities disclosed herein. In the illustrated implementation, storage 106 is represented as a single hardware component at a single node in one single computer 100. However, in various implementations, storage 106 may be distributed across multiple hardware components at different physical and network locations (e.g., in different computers).

The network interface 108 is a component that enables the computer 100 to connect to, and communicate over, any one of a variety of different external computer-based communications networks, including, for example, local area networks (LANs), wide area networks (WANs) such as the Internet, etc. The network interface 108 can be implemented in hardware, software, or a combination of hardware and software.

The input/output (I/O) device interface 110 is a component that enables the computer 100 to interface with any one or more input or output devices, such as a keyboard, mouse, display, microphone, speakers, printers, image scanners, digital cameras, etc. In various implementations, the I/O device interface can be implemented in hardware, software, or a combination of hardware and software. In a typical implementation, the computer may include one or more I/O devices (e.g., a computer screen, keyboard, mouse, printer, touch screen device, image scanner, digital camera, the input device 112, etc.) interfaced to the computer 100 via 110. These I/O devices (not shown in FIG. 2, except 112) act as human-machine-interfaces (HMIs) and are generally configured enable a human user to interact with the system 100 to access and utilize the functionalities disclosed herein.

In an exemplary implementation, the computer 100 is connected to a display device (e.g., via the I/O device interface 110) and configured to present at the display device a visual representation of an interface to an environment that may provide access to at least some of the functionalities disclosed here.

In some implementations, the computer 100 and its various components may be contained in a single housing (e.g., as in a personal laptop) or at a single workstation. In some implementations, the computer 100 and its various components may be distributed across multiple housings, perhaps in multiple locations on a network. Each component of the computer 100 may include multiple versions of that component, possibly working in concert, and those multiple versions may be in different physical locations and connected via a network. For example, the processor 102 in FIG. 3 may be formed from multiple discrete processors in different physical locations working together to perform processes attributable to the processor 102 as described herein, in a coordinated manner. A wide variety of possibilities regarding specific physical configurations are possible.

In various implementations, the computer 100 may have additional elements not shown in FIG. 2. These can include, for example, controllers, buffers (caches), drivers, repeaters, receivers, etc. The interfaces (e.g., 108, 110) in particular may include elements not specifically represented in FIG. 2, including, for example, address, control, and/or data connections to facilitate communications between the illustrated computer components.

The output device 114 can be any one of a variety of different types of device that may utilize the identity of the person (e.g., a computer screen or an intelligent personal assistant service), control access, for example, to a physical place or some other resource, which may be real or virtual. Examples of access control devices include physical locks, geographic access control devices such as turnstiles, electronic access control devices, access controls on computers, computer networks, computer applications, websites, etc.

FIG. 3 is a schematic representation of an exemplary implementation of a clustered DGCNN 200 that may be deployed, for example, on computer 100 to perform 3D hand shape recognition functionalities as disclosed herein. The input to the clustered DGCNN 200 in the illustrated implementation is a point cloud 201 representation (derived, e.g., from an RGB-D scan) of a scanned human hand. The outputs from the clustered DGCNN 200 are pose parameters 203 and shape parameters 205, all of which are derived from the input point cloud 201.

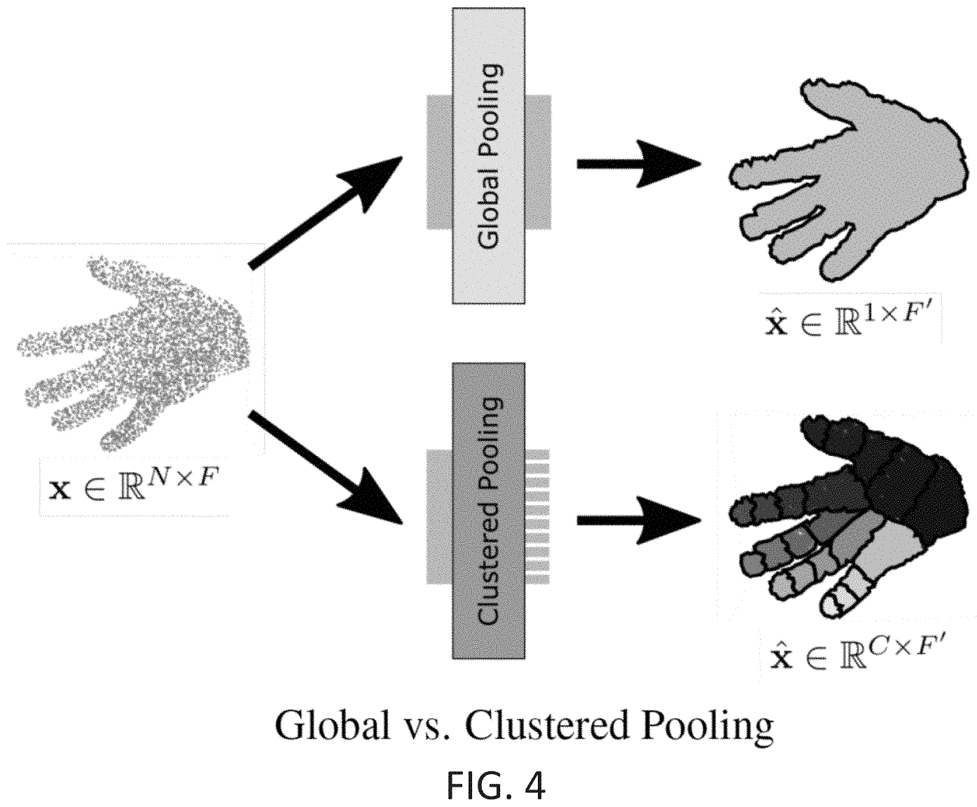

The human hand is a complex and highly non-rigid surface. Moreover, RGB-D scans (e.g., of a human hand) are often noisy. Matching noisy samples of hands using a global descriptor seems very challenging. An easier task would be to rather aim at describing the hand surface divided into semantically meaningful parts. In a typical implementation, these parts are pre-defined based on human anatomy, for example by looking at the skeletal structure of the hand. In a typical implementation these semantically meaningful parts define and correspond to the clusters that the clustered pooling module 220 uses to assign cluster probabilities. Such clustered description (see the output of clustered pooling in FIG. 4 for example) retains more information and should be robust against noise and, possibly non-rigid, transformations.

In a typical implementation, the clustered DGCNN 200 represented in FIG. 3, for example, is well-suited to address these and other challenges. In the following text, multilayer perceptron may be denoted as MLP(m, n, . . . ), where m, n, . . . are the number of parameters in each layer of the MLP. Moreover, the shape parameters space and pose parameter space are defined as S∈R¹⁰ and P∈R¹², respectively.

The clustered DGCNN 200 is organized into an upstream shared network 202, and two parallel-connected, downstream pose and shape regression networks 204, 206, respectively.

The shared network 202 includes two series-connected dynamic edge convolutional layers 208, 210. The first of the dynamic edge convolutional layers 208 in the illustrated implementation is configured to operate, as discussed below, with k=10 nearest neighbors and maximum feature aggregation type. The first dynamic edge convolutional layer 208 has MLP (2*3, 64, 64, 128).

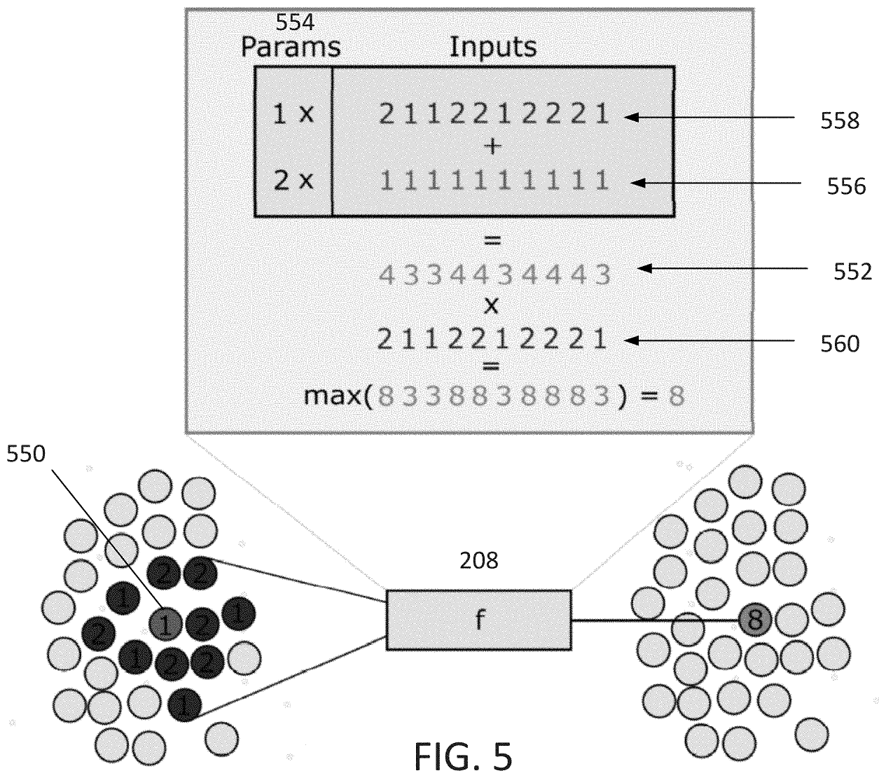

FIG. 5 is a schematic representation showing an example of at least some aspects of how a dynamic edge convolutional layer (e.g., 208 in FIG. 3) might operate.

According to the illustrated example, a new feature of point 550 is computed from its nearest neighbors (e.g., those represented by the darkened circles that surround point 550), using the learnable Dynamic Edge Cony Layer (e.g., 208 in FIG. 3), represented by “f” in FIG. 5, which is in the Shared Network 202 of FIG. 3. To compute the new feature of point 550, “f” first computes weights 552 that explain a relation between each of the nearest neighbors and point 550. In a typical implementation, the computer performs this calculation as a weighted sum of the feature vector 556 of point 550 with the feature vector 558 of each nearest neighbor point. The resulting weights are shown labeled as 552. The weights, denoted as “Params” 554, are learned. A value for each neighboring point 560 is then multiplied by its respective weight and the maximum is taken as the resulting new feature of point 5, shown in the figure on the right side of “f.” The maximum in the illustrated example is “8.”

Referring again to FIG. 3, the second of the dynamic edge convolutional layers 210 in the illustrated implementation is configured to operate with k=10 nearest neighbors and maximum feature aggregation type as well. The second dynamic edge convolutional layer has MLP (2*128, 256). In a typical implementation, outputs of both EdgeConv modules 208, 210 are concatenated and passed forward. The model is then forked into two branches, one regressing the pose parameters p E P and the other one regressing the shape parameters s E S of the input point cloud.

In a typical implementation, the second dynamic convolutional layer 210 acts in the same manner as the first dynamic convolutional layer 210 in terms of processing pipeline (see, e.g., FIG. 5), but the transformation they apply to their inputs are different for each layer, because the second dynamic convolutional layer 210 receives as input the output of the first dynamic convolutional layer 208 (so, they have different inputs), and the transformation they apply is learned from data and the stacking of these layers is to be able to represent more complicated non-linear functions as combinations of transformations these layers represent.

Based on how these layers (208, 210) work, stacking several (e.g., more than one) behind one another implicitly amplifies the neighborhood the information is aggregated from. Generally, the idea of stacking multiple layers like this in deep learning is used to be able to represent more complicated transformations of the data. In this particular case, the first layer 208 transforms the data into some representation that is more suitable for the task at hand. The purpose of stacking a second layer 210 is that we take the new representation and apply additional transformation to it to produce even better representation for the inputs that would not be possible to express directly with a single Dynamic Edge Conv Layer. It is believed that the system would work even with one such layer, but the performance is likely better with at least two such layers.

Referring again to FIG. 3, the pose regression network 204 includes, in series, a Global Pooling (GP) module 212 with MLP(128+256, 1024) followed by another sub-network MLP(1024, 512, 256, 12) made up of a pair of global FC layers with ReLU activation 214, 216, and a global FC layer with TanH activation 218. The term “global.” in this respect, refers to the fact that these layers process the data passing through them without clustering. Therefore, the pose parameters 203 produced by the pose regression network 204 represents a pose of the overall hand, not individual segments (or data clusters representing individual segments) of the hand. The first of the FC layers 214 has (1024, 512), the second of the FC layers 216 has (512, 256), the last of the FC layers 218 has (256, 12).

The convention MLP(x, y, w, z), for example, refers to a multilayer perceptron consisting of 4 layers with feature dimensions (w, x)→(x, y)→(y, z) and parentheses alone (e.g., (x, y)) applies to a fully connected layer (FC) which expects input features of dimension x and output features of dimension y.

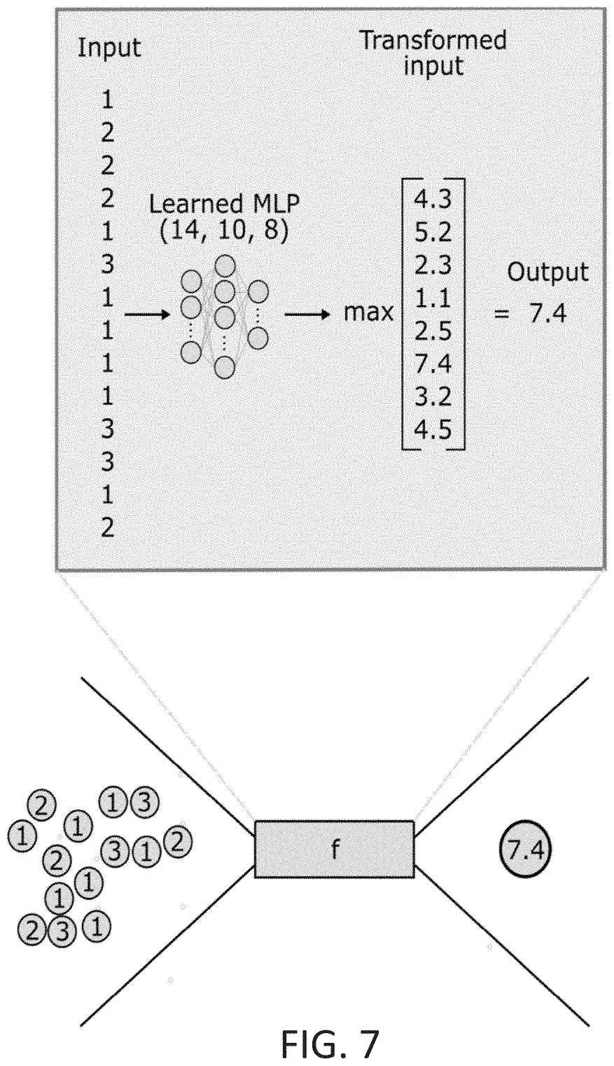

FIG. 7 is a schematic representation showing an example of at least some aspects of how an exemplary global pooling (GP) module might operate. The global pooling layer in FIG. 7 takes the input points, applies some non-linear transformation to them. The transformation is implemented using the MLP(14,10,8), which is an MLP consisting of two fully connected layers FC(14,10) and FC(10,8)). The result of this transformation produces the transformed input features shown in the figure. The output of the global pooling layer is then the maximum of transformed input features. The maximum operator can be also replaced by a different kind of operator (e.g., an averaging operator). The choice of this operator typically depends on the task at hand.

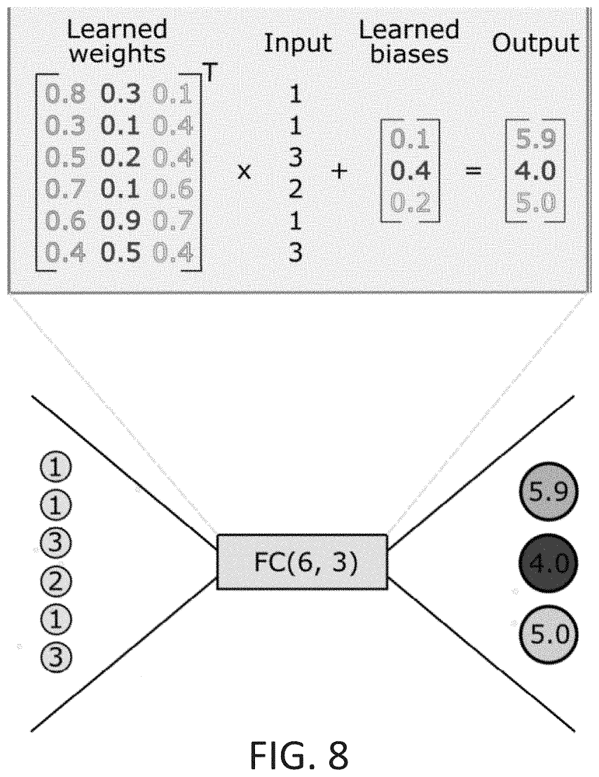

FIG. 8 is a schematic representation showing an example of at least some aspects of how an exemplary fully connected (FC) module might operate. A fully connected (FC) layer is a main building block of any neural network. It applies an affine transformation to the inputs (e.g., 1, 1, 3, 2, 1, 3) defined as ‘Wx+b’, where ‘W’ is the “learned weights” matrix, ‘b’ are the learned biases and ‘x’ is the input vector. The layer is called fully connected, because each output feature is influenced by all the input features (is connected to all the input features).

In a typical implementation, all of the FC modules in FIG. 3, for example, perform the same, only applying a different transformation typically which is learned from data. These transformations typically take the input and transform it to a space which is more suitable for the task at hand. This could mean, for example, that in case of object classification, during training it will be seeking a transformation of the data into another space, where the samples from different classes are ideally linearly separable (separable by a single straight line). If that cannot be found, a more complicated space where they can be separated by several straight lines can be found, or even more complicated spaces, etc. In a typical implementation, ReLU and TanH (of the FC layers in FIG. 3, for example) apply additional non-linear function to the output of the layer (so called activation functions). They are generally used to limit or rescale output values into certain range providing better gradient flow which can be important during training, for example.

Referring again to FIG. 3, the shape regression network 206 includes, in series, a clustered pooling module 220 with MLP(128+256, 512) followed by another sub-network MLP(512,512,256,10) made up of a pair of FC layers with ReLU activation 222, 224, an FC layer with a TanH activation 226, and a final FC layer with ReLU activation 228. The first of the FC layers 222 has (512,512), the second of the FC layers 224 has (512,256), the third of the FC layers 226 has (256,10). The final FC layer 228 has (210,10).

The clustered pooling module 220 in the illustrated implementation enables dynamically learning a clustering function 1: [symbol] ^{F}→ [symbol] ^{C}, which produces cluster assignment probability vector c∈ [symbol] ^{N×C} into C∈ [symbol] clusters for a vector of N∈ [symbol] feature points x∈ [symbol] ^{N×F} as:

$$c = softmax ( l ( x ) ) .$$

To get the clustered representation, the input feature points x∈ [symbol] ^{N×F} further undergo a non-linear transformation defined as f: [symbol] F→ [symbol] F′ and are subsequently aggregated into the C clusters as:

$$x f = f ( x ) , \\ \hat{x} = \frac{{c}^{T} {x}_{f}}{D} ,$$

where the division represents a Hadamard division, D∈ [symbol] ^{C×F} is a matrix with identical columns, where each column is defined as

$${( {\sum }_{i = 1}^{N} {c}_{i} )}^{T} ∈ {ℝ}^{C \times 1} and \hat{x} ∈ {ℝ}^{C \times {F}^{’}}$$

is the pooled representation of the transformed input x_{f}∈ [symbol] ^{F′}.

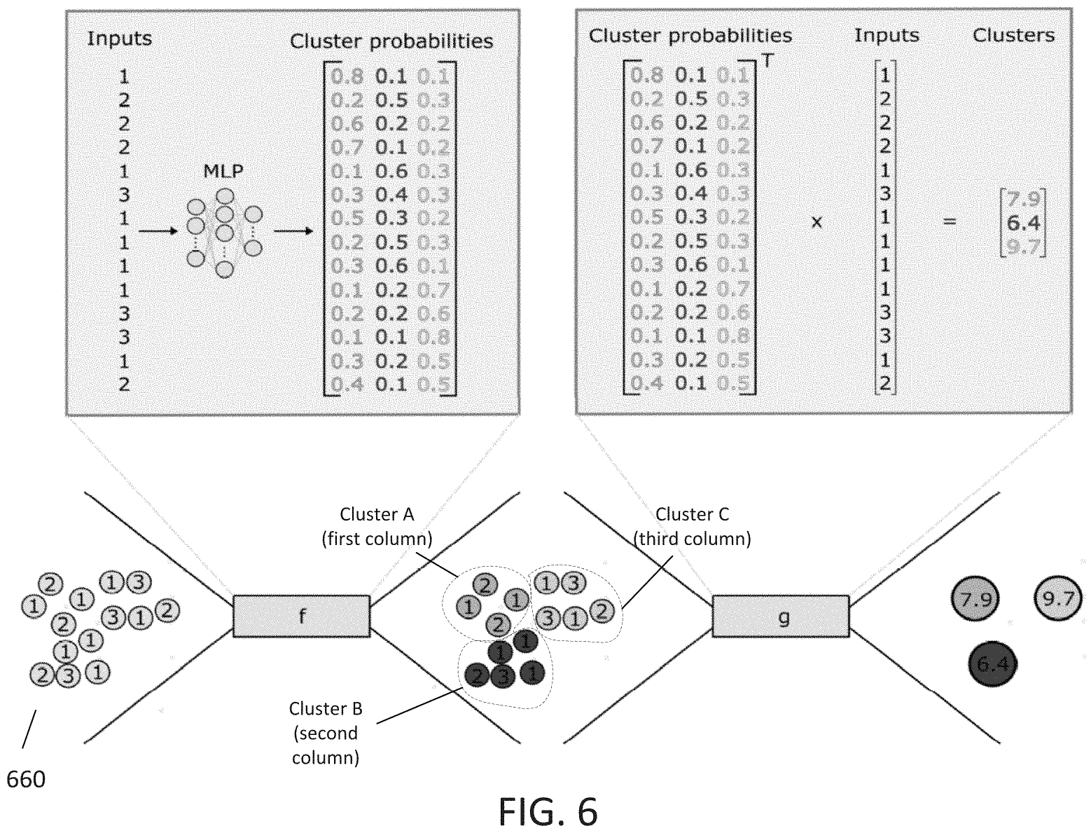

FIG. 6 is a schematic representation showing an example of at least some aspects of how the clustered pooling layer (e.g., 220 in FIG. 3) might operate. The clustered pooling layer represented in FIG. 6 learns to cluster points in a point cloud (e.g., those labeled as “inputs” and represented by numbered circles at the lower left portion of the figure) into C semantically meaningful clusters according to some data-dependent priors which are given to the model during training. In the illustrated example, the number of clusters (C) is three; however, C can be virtually any positive number greater than one. In case of a point cloud that represents a human hand, for example, the cluster centers could be (and/or correspond to) the hand skeleton joints.

The illustrated representation includes a cluster assignment module or function (“f”), which may be realized as a Multi-Layer Perceptron (MLP), and an aggregation module (“g”). Each point of the portion of the input point cloud 660 shown in the figure is represented by a circle that contains a value that corresponds to a value associated with its corresponding point. The values are also listed in the column labeled “inputs.” The portion of the input point cloud 660 shown in the figure has digital data points. The values associated with these data points (“inputs”) are first fed to the cluster assignment function (f) in the clustered pooling layer.

For each input data point, the cluster assignment function (f) assigns a probability that that input data point belongs to each respective one of the three different clusters. For example, in the illustrated implementation, for the first input data point (whose value is “1”) represented in the “inputs” column on the left, the MLP (“f”) calculates a probability of belonging to a first cluster as 0.8, a probability of belonging to a second cluster as 0.1, and a probability of belonging to a third cluster as 0.1. From this, it can be seen that first input data point most likely belongs to the first cluster and the system assigns it as such. As another example, in the illustrated implementation, for the second input data point (whose value is “2”) represented in the “inputs” column on the left, the MLP (f) calculates a probability of belonging to a first cluster as 0.2, a probability of belonging to a second cluster as 0.5, and a probability of belonging to a third cluster as 0.3. From this, it can be seen that second input data point most likely belongs to the second cluster and the system assigns it as such.

The figure (at 662) shows a clustering of the input data points according to their respective highest cluster probabilities. More specifically, the figure shows three clusters (A, B, and C) which correspond respectively to each of the three columns under the “cluster probabilities” heading from left to right. The first cluster (cluster A) has four of the input data points with values of 1, 1, 2, and 2. The first cluster (cluster A) data points are those that the cluster assignment module (f) determined to be more probably in the first cluster, than the other two clusters. The second cluster (cluster B) has five of the input data points with values of 1, 1, 1, 2, and 3. The second cluster (cluster B) data points are those that the cluster assignment function (f) determined to be more probably in the second cluster, than the other two clusters. The third cluster (cluster C) has five of the input data points with values of 1, 1, 2, 3, and 3. The third cluster (cluster C) data points are those that the cluster assignment function (f) determined to be more probably in the third cluster, than the other two clusters. The illustrated figure shows that every input data point (at 660) has been assigned, using the cluster assignment module (f), to one and only one cluster.

The cluster probabilities calculated by the cluster assignment module (f), are considered to be cluster assignment weights. The assignment based on the cluster probabilities are soft, meaning that one point can contribute to feature vectors from multiple clusters. Finally, to obtain the resulting feature for each cluster, the system feeds the original input points (“inputs”) together with the cluster assignment vector (“cluster probabilities”) to the aggregation module (g), which implements simple matrix multiplication of the two inputs as shown. The aggregation function (g) produces C outputs, in particular one aggregated feature vector for each output cluster. In the illustrated example, the aggregation function (g) produces three outputs: an aggregated feature vector of 7.9 for cluster A, an aggregated feature vector of 6.4 for cluster B, and an aggregated feature vector of 9.7 for cluster C.

Referring again to FIG. 3, according to the illustrated implementation, the point cloud 201 data enters the system 200 through the shared network 202. The shared network processes the data and outputs the same processed data to both pose regression network 204 and the shape regression network 206. The pose regression network 204 produces as an output a set of data (pose parameters 203) that represents a pose of the hand represented by the point cloud 201 that was input into the system 200. The shape regression network 206 creates multiple clusters of data based on the data the shape regression network 206 receives from the shared network 202, processes each cluster of data independently of the other clusters, and, after processing each cluster of data independently of the other clusters, produces as an output data (shape parameters 205) that represent a shape of the hand represented by the point cloud 201 that was input into the system 200.

According to an exemplary implementation, each respective cluster created by the shape regression network 206 corresponds to a particular physical region of the hand as represented by the point cloud 201, with each respective cluster corresponding to a different physical region than all the other clusters. The physical regions of the hand, in a typical implementation, may have been predefined, for example, based on anatomy of a human hand.

FIG. 4 schematically represents the qualitative difference between global pooling (as performed, for example, by the global pooling layer 212 of the pose regression network 204 in FIG. 3) and clustered pooling (as performed, for example, by the clustered pooling layer 220 of the shape regression network 206 in FIG. 3). The input data (x∈ [symbol] ^{N×F}), which corresponds to a point cloud representation of a hand) has N input feature points. Global pooling, according to the illustrated implementation, creates a single new descriptor (output vector \hat{X}∈ [symbol] ^{N×F′}) for the whole hand shape, whereas clustered pooling, according to the illustrated implementation, creates a new descriptor for each of the C semantically meaningful clusters (output vector \hat{X}∈ [symbol] ^{C×F′}). In the illustrated example, C equals twenty one (21).

The hand image shown at the input to both the global pooling function and the clustered pooling function, in the illustrated implementation, is whole (i.e., not segmented into different clusters). The output of the global pooling function also is whole (i.e., not segmented into different clusters). However, the hand image shown at the output of the clustered pooling function is segmented into twenty-one (21) different clusters.

Referring again to FIG. 1, the process also includes training the clustered DGCNN 200 (at 1004) with the training data (1008). In an exemplary implementation, the training data is provided in the form of a synthetic training dataset. Recent developments in hand pose estimation, make available a convenient, deformable model of three-dimensional hands called MANO (Model with Articulated and Non-rigid defOrmations), which is publicly available on the Mano website, http://mano.is.tue.mpg.de. (See, e.g., Romero, J., Tzionas, D., and Black, M. J. Embodied hands: Modeling and capturing hands and bodies together. Proc. SIGGRAPH Asia, 2017; Kulon, D., Wang, H., Guler, R. A., Bronstein, M. M., and Zafeiriou, S. Single image 3d hand reconstruction with mesh convolutions. Proc. BMVC, 2019; and Kulon, D., Guler, R. A., Kokkinos, I., Bronstein, M. M., and Zafeiriou, S. Weakly-supervised mesh-convolutional hand reconstruction in the wild. Proc. CVPR, 2020.). In this exemplary implementation, the pre-trained MANO hand model may be used to generate multiple different subjects (e.g., digital representations of a hands), whose shape and pose may be controlled by known shape and pose parameters. In one specific instance, for example, the pre-trained MANO hand model may be used to generate 200 subjects with 50 poses each, resulting in a total of 10000 three-dimensional hands, whose shape and pose was controlled via known shape parameters (s∈S) and known pose parameters (p∈P). In an exemplary implementation, the shape and pose parameters that are used to generate the different subjects (e.g., digital representations of hands) with MANO may be used (in 1006) in a supervised learning context, for example, to train the clustered DGCNN 200 to predict the shape and pose parameters of those generated subjects.

In a typical implementation, before feeding a hand point cloud to the model (at clustered DGCNN 200)—(e.g., in 1006 and in 1016)—it undergoes the following pre-processing steps. First, each point cloud is subsampled using Furthest Point Sampling (FPS) to some number of points (e.g., 4096). FPS starts with a random point as the first source and iteratively selects the furthest point from any already selected sources. FPS is desirable in some implementations as full resolution point clouds are often too big as inputs to a deep learning model (e.g., more than 100,000 points). Moreover, subsampling can attribute to reducing the effects of noise in the input data. FPS is generally the method of choice as it represents the original shape of the point cloud in the most complete way compared to other subsampling algorithms. Consequently, each sample is aligned to a reference hand point cloud using the Iterative Closest Point (ICP) algorithm, which iteratively seeks the best alignment between the source and reference point clouds. It serves as a pre-alignment step which should, in most instances, ease the work of the neural network model. In practice, we have found the method to work well both with and without ICP.

In an exemplary implementation, the optimization of the model is posed as a regression over the shape and pose parameters s∈S and p∈P, and simultaneous classification of the point clusters, while feeding a three-dimensional point cloud as an input. It is defined using the following objective function E for a batch of M∈N samples:

$$E = {E}_{S} + {λ}_{1} {E}_{p} + {λ}_{2} {E}_{clust} ,$$

where Es is the mean square error (MSE) loss for the regression of the shape parameters

$${E}_{S} = \frac{1}{M} {\sum }_{m = 0}^{M - 1} \vert {\hat{s}}_{m} - {s}_{m} {\vert}^{2} ,$$

E_{P} is the MSE loss for the regression of the pose parameters

$${E}_{p} = \frac{1}{M} {\sum }_{m = 0}^{M - 1} \vert \hat{{p}_{m} - {p}_{m} {\vert}^{2} ,}$$

### and E_{clust}

is a cross-entropy loss which enforces the classification of points into correct clusters. It is defined as

$${E}_{clust} = \frac{1}{M} {\sum }_{m = 0}^{M - 1} - log ( \frac{exp ( {c}_{m}^{{y}_{m}} )}{{\sum }_{j} exp ( {c}_{m}^{j} )} ) ,$$

where cm is the vector of cluster probabilities for points in a point cloud and y are the cluster labels of these points. The cluster assignment labels y are the indices of the closest skeleton joint position j∈J. Hyperparameter λ₁ is weighting the importance of regressing the pose parameters p∈P with respect to the shape parameters s∈S and λ₂ is a hyperparameter weighting the importance of the cluster classification loss.

Referring again to FIG. 1, next (at 1010), the illustrated process includes creating a database (1012) of hand geometry for system users. In various implementations, system users may be people who are authorized or have permission or approval to do or access something to which access may be otherwise restricted. More specifically, for example, an authorized user of a company's computer resources may be a person that has permission or approval to access the company's computer resources. Without such permission or approval, access to the company's computer resources may be blocked.

In an exemplary implementation, this step (1010) may include scanning the hands of authorized users to create point clouds that represent those hands; processing the point clouds with the trained clustered DGCNN to generate shape parameters (s∈S) and/or pose parameters (p∈P) that correspond to the authorized users' hands; and storing the generated shape parameters (s∈S) and/or pose parameters (p∈P) in computer memory (e.g., 104 or 106 of FIG. 2) in a database format, (optionally) in logical association with other hand geometry information (e.g., the associated point cloud) and/or user identification information, etc.

Once a system (e.g., system 120 in FIG. 2) has been set up as described above, the system 120 awaits some further action (e.g., by a human candidate seeking to access, for example, to a company's private computer resources, which would otherwise be restricted). In the illustrated flowchart, this further action comes in the form of an access or authorization request that the clustered DGCNN 200 receives at 1014. The access or authorization request in the illustrated example is or includes biometric data of the human candidate. More specifically, in a typical implementation, the biometric data includes a point cloud representation of a scanned image of the human candidate's hand that is based, for example, on an image captured by the system's 120 input device 112.

Next, the clustered DGCNN 200 (at 1016) generates hand geometry data (e.g., shape parameters (s∈S) and/or pose (p∈P) parameters) based on the candidate's scanned biometric data, as represented in a point cloud representation of the candidate's hand from the scan. The shape and pose parameters are generated by the DGCNN 200 in accordance with the techniques set forth above.

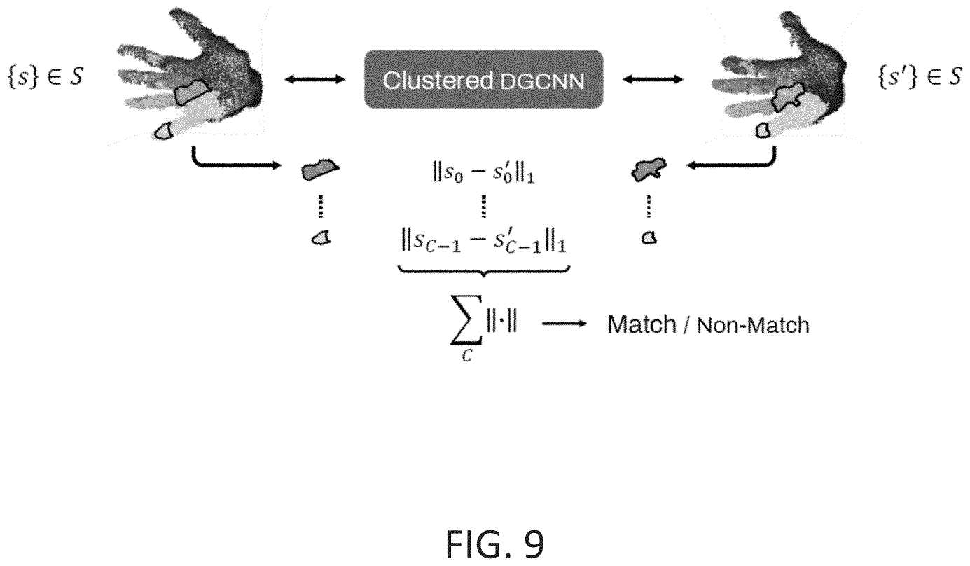

The system 102 then (at 1018) compares the shape and/or pose parameters generated from the point cloud representation of the requestor's hand scan to hand geometry data (e.g., shape and pose parameters) for authorized system users saved in database 1012. FIG. 9 shows an example of comparison that the computer 100 may make to compare, on a cluster-by-cluster basis, the shape parameters for a point cloud of a requestor's hand {s} (from input device 112) to the shape parameters of an authorized user's hand {s′} (e.g., from the hand geometry database 1012). According to the example shown in FIG. 9, the two sets of shape parameters for corresponding clusters in each point cloud are compared to one another. More specifically, according to the illustrated implementation, for each cluster (where there are C clusters), the system subtracts the shape parameters for the authorized user's hand from the shape parameters for the requestor's hand. This results in a plurality of cluster-specific similarity measures. The system then sums up all of the calculated differences (or cluster-specific similarity measures)— i.e., the difference calculated for every cluster is added together. This produces an overall similarity measure. The computer then compares this sum (i.e., the overall similarity measure) against a predefined threshold value (e.g., stored in memory) to determine whether the requestor's hand is sufficiently similar to the authorized user's hand to be considered a match. In essence, therefore, the computer compares the shape parameters of the two hands on a cluster-by-cluster basis.

In a typical implementation, if the computer concludes that a match exists, then the computer essentially concludes that the same hand was involved in both scans. If the computer concludes that two hand scans do not match, the computer essentially concludes that different hands were involved in the scans.

In a typical implementation, the system compares the shape parameters of the requestor's hand with the shape parameters of all of the authorized users (stored in the hand geometry database) until a match is found.

If the system 102 determines (at 1020) that the shape parameters, for example, associated with the scanned requestor's hand sufficiently match the shape parameters associated with any of the authorized system users, then the system 102 (at 1022) grants the requestor's authorization or access request. In a typical implementation, the grant may come from the system 102 in the form of a removal of any access barriers at the output device 114.

If the system 102 determines (at 1020) that the shape and/or pose parameters associated with the scanned requestor's hand do not sufficiently match the shape and/or pose parameters associated with any of the authorized system users, then the system 102 (at 1024) rejects the requestor's authorization or access request.

In a typical implementation, the shape and/or pose parameters associated with the requestor's hand scan need not matches the shape and/or pose parameters of an authorized system user exactly. Typically, the system 102 grants access (at 1022) as long as the similarity between the shape and/or pose parameters associated with the requestor's hand scan and the shape and/or pose parameters of an authorized system user exceeds some minimum threshold. In an exemplary implementation, for matching, the system 120 considers the per-cluster shape parameters as the output feature vector in case of the clustered DGCNN 200. In the implementation represented in FIG. 4, for example, there are 21 different clusters which results in a vector of 210 dimensions. Different metrics have been tried for computing the distance, where the L1 distance has shown to be the most suitable one. L1 distance (sometimes also called Manhattan distance) is a distance measure between two entities I1 and I2 with p components computed as

$$d ( {I}_{1} , {I}_{2} ) = {\sum }_{p} \vert {I}_{1}^{p} - {I}_{2}^{p} \vert$$

After the system 102 either grants the requestor's request (at 1022) or rejects the requestor's request (at 1024), the system 102 reenters a waiting period, waiting for a subsequent user access or authorization request, for example.

### Experiments

The following sections describe the datasets that have been used, the two simple baseline methods we compare to and results in different scenarios.

### Datasets

Synthetic Training Dataset

We used the pre-trained MANO hand model to generate 200 subjects with 50 poses each, resulting in a total of 10000 three-dimensional hands, whose shape and pose was controlled via s ∈ S and p∈P. The inputs to the MANO model are the shape and pose parameters from shape space S and pose space P. These spaces are learned during training of MANO model. The output of MANO model is a 3D mesh with its 3D skeleton. What we desire, however, is a point cloud as if the 3D mesh was seen by a 3D camera in real world. To create this representation, we use an open-source library OpenDR, which provides functionality to reproject the three-dimensional meshes into range data (point clouds) viewed from a specific viewpoint, as if it was acquired by a 3D camera in real-world scenario. Using OpenDR DepthRenderer applied to the 3D mesh, finally we obtain point cloud vertices V.

Subject metadata used in this regard may include, in one implementation for example, subject ID, shape parameters S∈ [symbol] ¹⁰ pose parameters P∈ [symbol] ¹² point cloud vertices V∈ [symbol] ^{N×3}, and joint positions J∈ [symbol] ^{21×3}.

### Testing Datasets

Extensive evaluation of the approach disclosed herein on both the new dataset and a standard benchmark HKPolyU has been carried out. (See, e.g., Kanhangad, V., Kumar, A., and Zhang, D. Combining 2d and 3d hand geometry features for biometric verification. Proc. CVPR, 2009; and Kanhangad, V., Kumar, A., and Zhang, D. Contactless and pose invariant biometric identification using hand surface. IEEE Transactions on Image Processing, 20(5):1415-1424, 2011.)

### Input Point Cloud Pre-Processing

Before feeding a hand point cloud to a model, it underwent the following pre-processing steps. First, each point cloud was subsampled using Furthest Point Sampling (FPS) to 4096 points. Consequently, each sample is aligned to a reference hand point cloud using the Iterative Closest Point (ICP) algorithm.

### Baseline Methods

State-of-the-art algorithms in deep learning on point clouds have been used as baselines. In particular, the PointNet++(see, e.g., Qi, C. R., Yi, L., Su, H., and Guibas, L. J. Pointnet++: Deep hierarchical feature learning on point sets in a metric space. Proc. NIPS, 2017) architecture, PointNet++ and Big PointNet++ baselines, successor of the PointNet (Qi, C. R., Su, H., Mo, K., and Guibas, L. J. Pointnet: Deep learning on point sets for 3d classification and segmentation. Proc. CVPR, 2016), and the Dynamic Graph CNN (see, e.g., Wang, Y., Sun, Y., Liu, Z., Sarma, S. E., Bronstein, M. M., and Solomon, J. M. Dynamic graph CNN for learning on point clouds. ACM Transactions on Graphics (TOG), 38 (5), 2019), DGCNN and Big DGCNN baselines, which are both implemented as a part of PyTorch Geometric library (see, e.g., Fey, M. and Lenssen, J. E. Fast graph representation learning with PyTorch Geometric. In Proc. ICLR Workshop on Representation Learning on Graphs and Manifolds, 2019).

### Feature Matching

Matching involved consideration of the per-cluster shape parameters as the output feature vector in case of the clustered DGCNN. There were 21 different clusters which resulted in a vector of 210 dimensions. For a fair comparison, in case of PointNet++ and DGCNN baselines, which both perform a global pooling, the output of the layer before the last in the shape regression network was taken as the feature vector, which has 256-dimensions. Different metrics were tried for computing the distance, where the L1 metric has shown to be the most suitable one.

### Results

We evaluated our method in both All-To-All and Reference-Probe matching scenarios. Employed dataset splitting strategies for different datasets are described in below. In both scenarios, the clustered DGCNN outperformed both baselines by a margin and sets new state-of-the-art on the NNHand RGB-D dataset as well as HKPolyU v1 and v2 standard benchmarks.

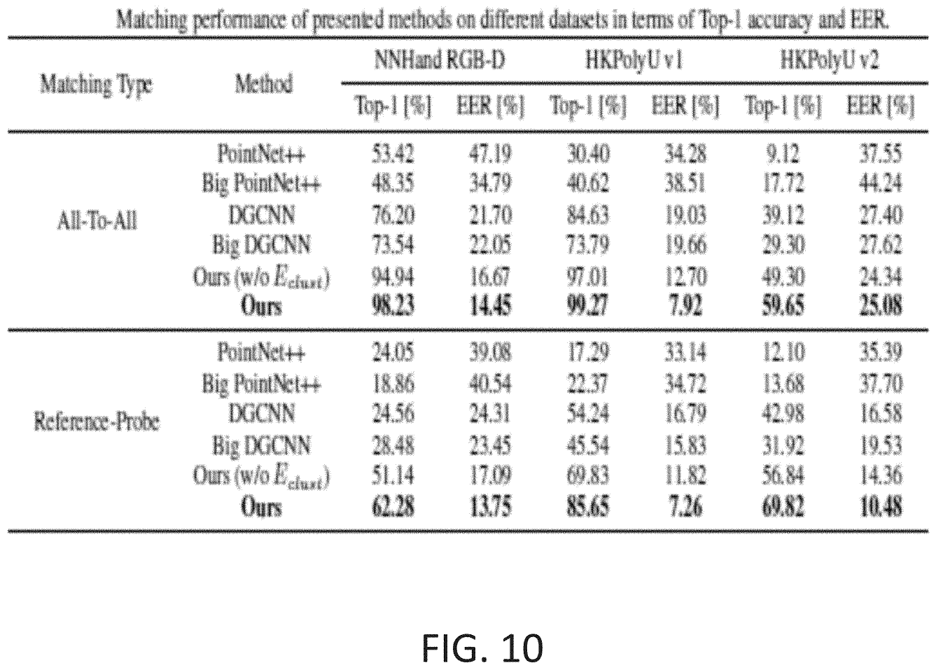

We showed the importance of the novel clustering loss by additionally comparing to a clustered DGCNN model trained without it (e.g., w/o E_{clust} in the table of FIG. 10, for example). Compared to the results of (Kanhangad et al., 2011), which operates on full-resolution point clouds (e.g., tens of thousands of points), we used heavily down sampled inputs and yet obtained on-par or superior performance compared to these original works. Remarkably, in case of reference—probe matching on the HKPolyU v2 dataset, we can compare to the results presented by (Kanhangad et al., 2011), where we outperformed their method in terms of EER by a huge margin of 7% (which is an improvement by 60% compared to their EER of 17.2%). This further supports the high potential of implementations of the systems and/or techniques disclosed herein.

FIG. 10 is a table presenting matching performance of presented methods on different datasets in terms of Top-1 accuracy and EER. The table includes data for each one of a plurality of methods, including an implementation of the clustered DGCNN techniques disclosed herein (labeled “Ours”), for two different matching types: All-To-All and Reference-Probe. The method types are PointNet++, Big PointNet++, DGCNN, Big DGCNN, Ours (without E_{clust}), and Ours. The table includes data for NNHand RGB-D, HKPolyUv1, and HKPoluUv2.

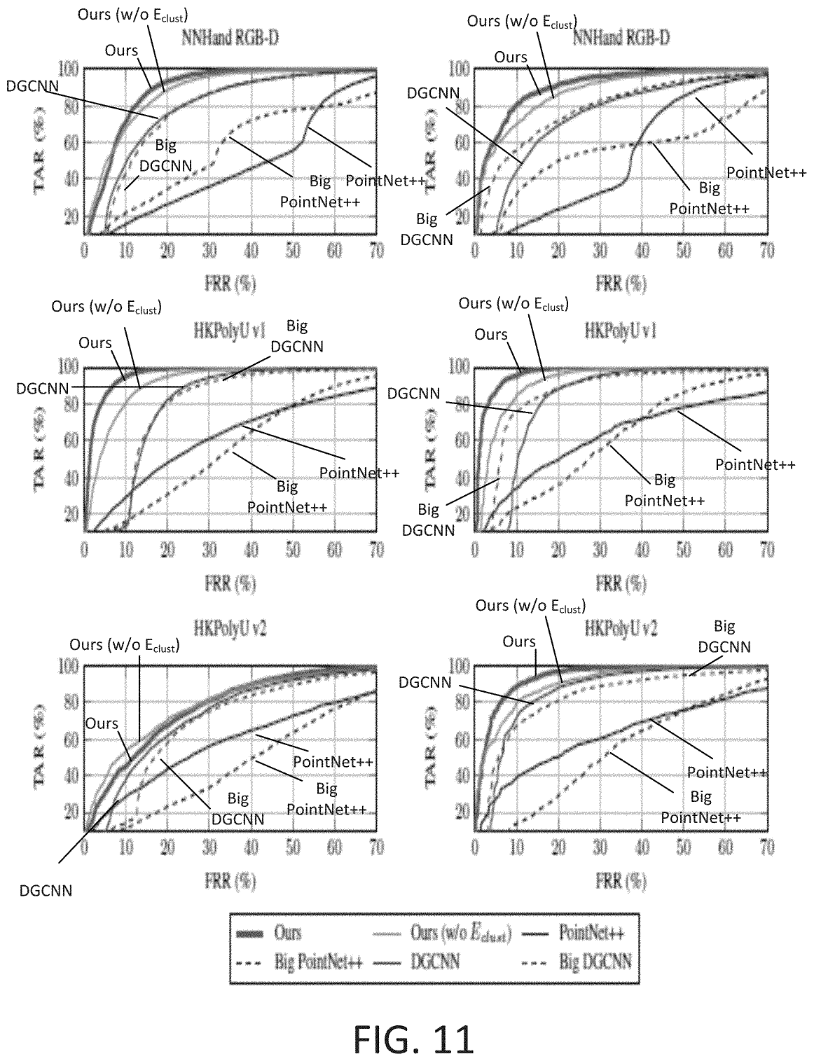

FIG. 11 includes graphs that plot True Accept Rate (TAR (in percentage)) versus False Reject Rate (FRR (in percentage)) for various approaches (represented by different lines) and with different data sources. True accept rate refers, for example, to the probability that the system correctly accepts an authorized person. False Reject Rate refers, for example, to the probability that the system incorrectly rejects an authorized person. The three graphs on the left side of FIG. 11 apply to All-To-All matching ROC curves (tradeoff between acceptance and rejection rates) of the presented methods on different datasets. The three graphs on the right side of FIG. 11 apply to reference-probe matching ROC curves (tradeoff between acceptance and rejection rates) of the presented methods on different datasets.

### NNHand RGB-D Dataset

This section introduces a new dataset of human hands collected for the purpose of evaluating hand biometric systems. The first version of the dataset, with suffix v1, comprises of 79 individuals in total. It is planned to continue collecting extended version v2 with the aim of about 200 different identities.

The dataset is collected using an off-the-shelf range camera Intel RealSense SR-300 in different environments and lighting conditions. Each person contributing to the dataset is asked to repeatedly perform three different series of gestures with the hand in front of the camera, resulting in three RGB-D video sequences collected for each participant. Each subject in the dataset has the following annotations: User ID, Gender and Age. The dataset is mainly targeting three-dimensional hand shape recognition. However, the presence of RGB-D information also allows attempting two-dimensional shape or palmprint recognition. Attempting palmprint recognition on this dataset might however be extremely challenging due to the poor quality of the RGB data in many sequences.

### Video Sequences

There are three types of gestures that each participant is asked to perform repeatedly four times. Between the gestures, the participants are asked to remove their hands from the scene and re-enter. This naturally forces them to re-introduce the hand in the scene each time and provides more diverse and realistic samples.

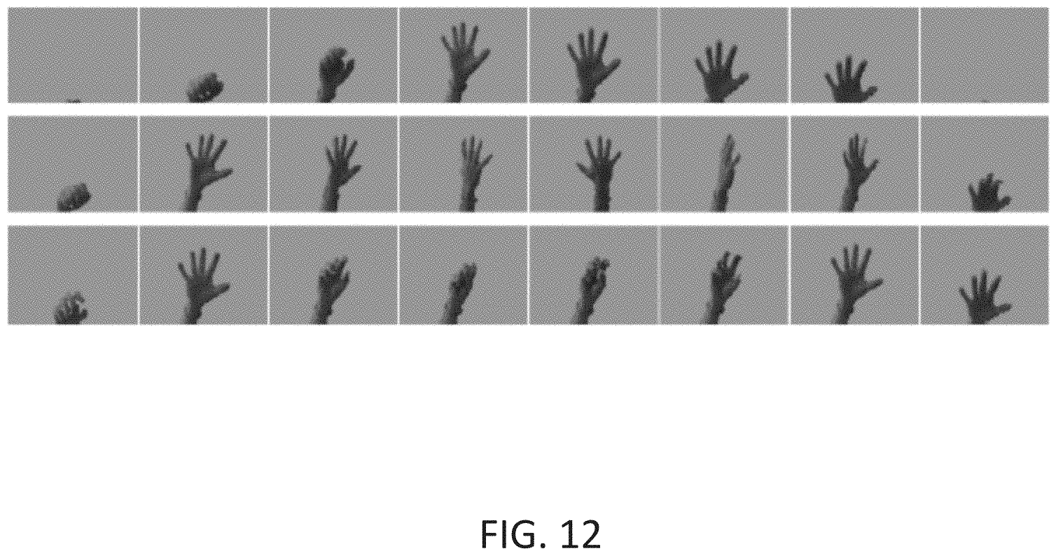

The recorded video sequences are depicted in FIG. 12. More specifically, FIG. 12 shows the three sequences (one in each row) recorded for each subject in the dataset. The first sequence is sliding hand vertically into the scene with an open palm and removing it again, repeatedly. In the second sequence, rotation of the hand is added when the hand is upright. In the last sequence, the user closes and reopens the first while the hand is upright.

A more detailed description of the dataset can be found on the project webpage, which is https://handgeometry.nnaisense.com/.

### Applications

The main purpose of the dataset is to serve as a new evaluation benchmark for three-dimensional hand shape recognition based on a low-cost sensor. The dataset allows for experiments with non-rigid three-dimensional shape recognition from either dynamic video sequences or static frames as well as attempts to perform recognition viewing the hand from either its palm or dorsal side. Additionally, the Gender and Age information can be used for experiments aiming at recognizing the gender or age of a person based on the shape of their hand.

### Experimental Setup

The following sections describe the datasets that have been used, the two simple baseline methods we compare to and results in different scenarios.

### Datasets

Synthetic training dataset Recent developments in hand pose estimation have provided us, besides others, with a very convenient deformable model of three-dimensional hands called MANO, referred to above, which is publicly available. It allows generating hands of arbitrary shapes in arbitrary poses. The generation of hand sample is controlled by two sets of parameters. First are the so-called shape parameters in space

$$S ⊆ {ℝ}^{10}$$

that define the overall size of the hand and lengths and thickness of the fingers. The second group of parameters are the pose parameters in space

$$P ⊆ {ℝ}^{12}$$

where the first 9 parameters define the hand pose in terms of non-rigid deformations (e.g., bending fingers, etc.) and the last 3 parameters define the orientation of the whole hand in the three-dimensional space. We use the pre-trained MANO hand model to generate 200 subjects with 50 poses each, resulting in a total of 10000 three-dimensional hands, whose shape and pose is controlled via

$$s ∈ S and p ∈ P .$$

Such three-dimensional models can be easily reprojected into range data.
NNHand RGB-D database

A dataset of fixed RGB-D frames has been sampled from the video sequences. For each subject, the sequence number 1 has been taken and 10 samples have been acquired while the hand is held straight up with the fingers extended and palm facing the camera. The dataset at one point contained 79 subjects, which gives a total of 790 samples. Similarly, the sequence number 2 has been used to obtain a second set of 790 samples. For reproducibility of this evaluation, the acquired subset of RGB-D frames is stored (e.g., in computer-based memory) together with the original NNHand RGBD dataset. Each frame captured from the video sequences undergoes several pre-processing steps.

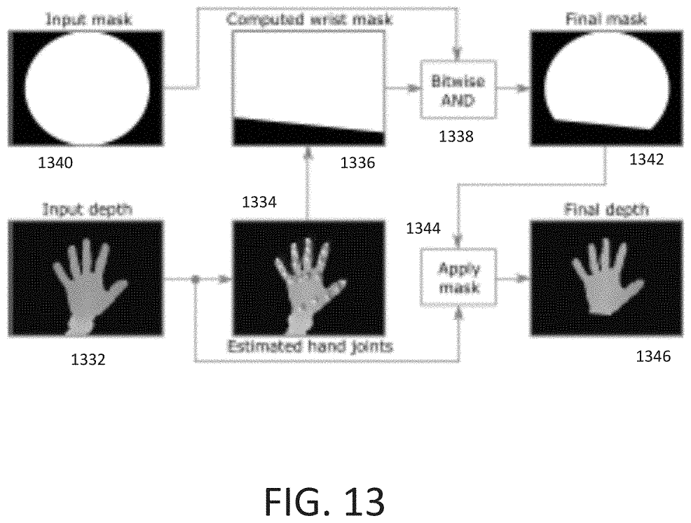

First, the background is removed using the depth information. Subsequently, to avoid problems with objects or other parts of the body appearing in the frames, a mask keeping only the central area of each frame is applied (see FIG. 13). Next, an OpenPose-based (Cao, Z., Hidalgo, G., Simon, T., Wei, S.-E., and Sheikh, Y. Realtime multi-person 2d pose estimation using part affinity fields. Proc. CVPR, 2017.) single RGB image hand pose estimator is used to estimate the hand keypoints. Thanks to the one-to-one mapping between RGB and depth information, this allows to filter out the undesired part of the hand below the wrist in the whole RGB-D frame. Step-by-step preprocessing of a random frame is depicted in FIG. 13 where each sample in the dataset undergoes the indicated pre-processing steps.

As the first step in the illustrated implementation, the computer (at 1332) determines an input depth (e.g., from the depth channel of the RGB-D frame) and uses (at 1334) the OpenPose public library to detect or estimate positions of the skeleton joints. In a typical implementation, the computer uses the wrist joint to compute (at 1336) an area of interest in the image called a wrist mask. In a typical implementation, this should cut-off the part of the hand below the wrist, which is not typically an object of interest for hand shape recognition. The computer 100, according to the illustrated implementation, (at 1338) combines this with an input mask 1340 (which may be hand-made, for example), which assumes that the hand is centered in front of the camera and so the corners will likely contain noise, which we want to discard. The combination in the illustrated example is performed by a bitwise AND (at 1338). Consecutively, the computer combines the two masks into the final mask (at 1342). The computer (at 1344) applies the final mask (1342) as a filter to the point cloud (1332) to pass the object of interest in the input data (i.e., the point cloud) and discard potential noise to produce an output (1346).

### HKPolyU v1 Database

A dataset of 177 subjects containing in total 1770 RGB-D samples that were acquired with high precision Minolta Vivid 910 range scanner. Each subject had been scanned in two sessions in different time periods, obtaining 5 samples per session. The precision of the data was enough to perform both 3D hand geometry and 3D palmprint recognition.

### Hkpolyu v2 Database.

It is a dataset of 114 subjects with a total of 570 RGB-D samples that were acquired using the Minolta Vivid 910 range scanner. Each subject had been scanned 5 times, each time presenting his hand on different global orientation. Besides, the precision of the data is enough to perform both 3D hand geometry and 3D palmprint recognition.

### Input Point Cloud Pre-Processing

Before feeding a hand point cloud to a model, it undergoes the following pre-processing steps. First, each point cloud was subsampled using Furthest Point Sampling (FPS) to 4096 points. Consequently, each sample was aligned to a reference hand point cloud using the Iterative Closest Point (ICP) algorithm.

### Baseline Methods

Two state-of-the-art algorithms in deep learning on point clouds have been used as baselines. In particular, the PointNet++ architecture, successor of the famous PointNet, and the Dynamic Graph CNN (DGCNN), which are both implemented as a part of PyTorch Geometric library.

### PointNet++

The baseline PointNet++ architecture has two Set Abstraction (SA) modules. The first SA module has subsampling ratio r=0.5, neighborhood radius ρ=0.2 and MLP(3; 64; 64; 128). It is followed by second SA module with r=0.25; ρ=0.4 and MLP(3+128; 128; 128; 256). The output of the second SA module is forked into two parallel branches. The first branch is supposed to output the shape parameters s Σ S. It is composed by a Global Abstraction (GA) (Qi et at, 2017) module with MLP(3+256; 256; 512; 1024) followed by another MLP subblock defined as MLP(1024; 512; 256; 10). The second branch, instead, is outputting the pose parameters p E P and is composed of a GA module with MLP(3+256; 256; 512; 1024) whose output is fed to an MLP module MLP(1024; 512; 256; 12).

### Big PointNet++

Second version with more parameters has been evaluated in parallel. This model has a bigger subnetwork for the shape regression. In particular, the GA module is equipped with MLP(3+256; 256; 512; 1024×21) whose output is fed to an MLP module MLP(1024×21, (1024×21)/12, (1024×21)/24, 10×21, 10).

Dynamic Graph CNN (DGCNN) the Model Starts with

Two EdgeConv modules, both with k=10 and max aggregation type. The first module has MLP(6; 64; 64; 128) and the latter one MLP(128+128; 256). Outputs of both EdgeConv modules are concatenated and passed forward. The model is then forked into two branches, one regressing the pose parameters p E P and the other one the shape parameters s E S of the input point cloud. The first branch composed of a GA module with MLP(128+256; 1024) followed by another MLP subblock with defined as MLP(1024; 512; 256; 12). The second branch is almost the same, with only one difference: The final MLP block's output is 10-dimensional as it outputs the shape parameters s.

### Big DGCNN

Second version with more parameters has been evaluated in parallel. This model has a bigger subnetwork for the shape regression. In particular, the GA module is equipped with MLP(128+256; 1024×21) whose output is fed to an MLP module MLP(1024×21; (1024×21)/12, (1024×21)/24, 10×21, 10).

### Matching Scenarios and Splitting Strategies

### All-to-All Matching

In this experiment, each output feature vector is taken and its distance to feature vectors of all other samples in the dataset is computed. The sample with the shortest distance is taken as the matching class.

### Reference-Probe Matching

A very popular way of evaluating biometric algorithms on diverse datasets is performing so-called reference—probe matching, where the dataset is split into two parts, one is the reference (i.e., the database) and the rest is the probe (i.e., the samples one wants to identify). Different splitting strategies have been applied depending on the dataset at hand.

For the HKPolyU v1 dataset, the splitting strategy proposed by (Kanhangad et al., 2009) is followed, choosing the 5 samples from the first session as the reference and the 5 samples from the second session as the probe for each user.

In case of HKPolyU v2, we use the splitting strategy used in (Kanhangad et al., 2011), where 1 sample is chosen as probe and all the other 4 as reference. This process is repeated 5 times, always picking different sample as the probe to produce the genuine and impostor scores for the generation of the ROC curve and computation of the EER.

NNHand RGB-D database has 10 samples per user from sequence 1 and another 10 samples from sequence 2. For each user, the 10 samples from sequence 1 are selected as the reference and the other 10 samples from sequence 2 are left as the probe.

### Semantic Segmentation Analysis

Our method (Clustered DGCNN), besides others, outputs the semantic segmentation of the point cloud into parts, which the network was enforced to learn during training by the cluster assignment loss, see, e.g.:

$$E = {E}_{S} + {λ}_{1} {E}_{p} + {λ}_{2} {E}_{clust} ,$$

using the cluster annotations provided with the synthetic training samples.

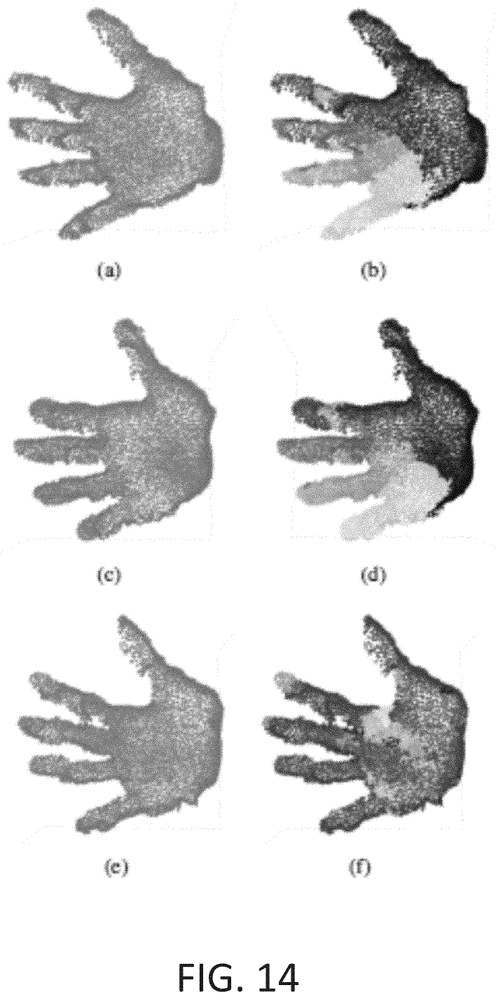

There is no ground truth segmentation for the testing data and thus we provide a qualitative evaluation in FIG. 14, which supports that the Clustered DGCNN has learnt to segment the point cloud in a meaningful way. In FIG. 14, the first two rows show clustering of points computed by Clustered DGCNN for two real samples. One can notice some inconsistencies around some of the fingers. Last row shows the effect of omitting clustering loss E_{clust} during training. (a,c,e) The original point cloud; (b,d,e) Result of clustering the point cloud. Aggregating information inside each cluster, therefore, provides a meaningful piece-wise representation of the point cloud.

One should notice that due to the presence of noise in the input point clouds, the segmentation is prone to produce some outliers in the finger regions (see FIG. 14). Influence of such inconsistencies on the final descriptor is reduced by averaging feature vectors in each semantic region in order to produce the global segment descriptor (i.e., a cluster).

### Ablation Study

Two ablation studies are performed in order to justify our architecture design choices as well as the employed loss function.

### Clustered Pooling Layer

To clarify that the novel architecture does not perform better only because its increased capacity compared to the classical PointNet++ and DGCNN, we created their extended versions, which we call Big PointNet++ and Big DGCNN, respectively. The architectures are the same, but the number of parameters in the shape regression subnetwork is changed (see above for details).

The results in FIGS. 10 and 11 show that simply increasing the network capacity does not result in noticeable performance gain in most cases.

### Semantic Hand Clustering

We train another version of Clustered DGCNN without the cluster assignment loss Eclust to demonstrate its importance. An example of the learnt segmentation without Eclust is shown in the last row of FIG. 14. Compared to our novel solution (the first two rows in the figure), there is no apparent meaning to the produced segmentation of the hand. Moreover, by far not all of the 21 available clusters are well exploited. The results in FIGS. 10 and 11 confirm that without semantically meaningful clustering, the solution is less robust and yields significantly lower performances especially in the case of reference-probe matching.

### EdgeConv Modules

Further detail about exemplary implementations of dynamic edge convolutional layers (or “EdgeConv” modules) are described in detail in an article by Wang, Yue, et al., entitled “Dynamic Graph CNN for Learning on Point Clouds,” ACM Transactions on Graphics, Vol. 30, No. 5, Article 146, Publication date: October 2019 (hereinafter, “Wang 2019”), which is incorporated by reference herein in its entirety. As discussed in Wang 2019, in a typical implementation, an EdgeConv module is configured to capture local geometric structure based on the input point cloud typically while maintaining permutation invariance.

A number of embodiments of the invention have been described. Nevertheless, it will be understood that various modifications may be made without departing from the spirit and scope of the invention.

For example, the systems and techniques disclosed herein are described as being utilized in connection with three-dimensional (3D) hand shape recognition. However, in various implementations, the systems and techniques may be adapted to other types of biometric systems and/or other types of recognition systems. For example, in some implementations, the systems and techniques disclosed herein could be applied to face recognition. Similarly, the biometric recognition can be utilized for any one of a variety of purposes including, for example, simple user identification, security, etc.

The specific structure and component configuration of the system (e.g., 120 in FIG. 2) can vary considerably and may include any one or more of a variety of different types of hand scanners/cameras, as well as any one or more of a variety of output devices. Similarly, the specific configuration of the computer components can vary as well.

The specific configuration of the DGCNN (e.g., 200 in FIG. 3) can vary considerably. More specifically, the number of layers, types of layers, layer parameters, and activation functions in the various sections of the DGCNN can vary. For example, the exemplary shared network of the DGCNN is described as having two dynamic edge convolutional layers. However, in some implementations, the shared network of the DGCNN may have only one dynamic edge convolutional layer. Likewise, in some implementations, the shared network of the DGCNN may have more than two dynamic edge convolutional layers. Moreover, the parameters associated with the dynamic edge convolutional layers of the DGCNN can vary as well.

Similarly, the parameters and other characteristics of the global pooling layer in the pose regression network and the clustered pooling layer in the shape regression networks can vary. Also, the parameters and activation functions for the fully connected layers can vary as well. Moreover, in various implementations, the DGCNN may include more, or fewer, fully connected layers than shown, and/or their specific configuration and distribution between the various DGCNN networks can vary.

Clustering may be performed in wide variety of ways. In various implementations, the clustering may be adapted to produces a different configuration of clusters and/or a different number of clusters than described herein. Likewise, the matching algorithm represented, for example, in FIG. 9, can be performed in any one of a wide variety of ways that compare on a cluster-by-cluster basis associated parameters.

DGCNN training is described herein as utilizing a synthetic training dataset. This, too, can vary. The specific method of generating the synthetic training can potentially vary. Moreover, in some implementations, DGCNN training may be performed utilizing a dataset that has not been synthetically generated.

The similarity measures may be computed in different ways, as long as the similarity measures produce an indication of similarity between corresponding clusters from different point cloud hand representations. Moreover, the similarity measures for the individual clusters can be combined in a variety of different ways (including, for example, a simple summing or something more involved) to produce an overall indication of similarity between the two hands.

The description above describes comparing shape parameters associated with two hand scans. However, in some implementations, the same type of comparison could be made, without clustering, based on the pose parameters. In some such instances, a match/no match may be determined by generating some combination of the per cluster shape parameter differences and the pose parameter differences (e.g., by addition, etc.), and those values for the two hand scans may be compared looking for a minimum threshold difference to establish a match.

The way data preprocessing is done may vary as well. There are many ways of implementing data preprocessing suitable for the task at hand and so the rest of the system will work independently of these. Some steps, as for example ICP alignment might be even omitted completely.

Pose parameters do not generally come into play in the biometric recognition. They can be important during training or pre-alignment of the model before the recognition itself, however. Training a network to regress both shape and pose parameters, we are trying to make the model de-couple shape and pose information. Thus, the model should output shape parameters which are less-dependent or ideally independent of the current hand pose.

It should be understood that the example embodiments described herein may be implemented in many different ways. In some instances, the various methods and machines described herein may each be implemented by a physical, virtual, or hybrid general purpose computer, such as a computer system, or a computer network environment, such as those described herein. The computer/system may be transformed into the machines that execute the methods described herein, for example, by loading software instructions into either memory or non-volatile storage for execution by the CPU. One of ordinary skill in the art should understand that the computer/system and its various components may be configured to carry out any embodiments or combination of embodiments of the present invention described herein. Further, the system may implement the various embodiments described herein utilizing any combination of hardware, software, and firmware modules operatively coupled, internally, or externally, to or incorporated into the computer/system.

Various aspects of the subject matter disclosed herein can be implemented in digital electronic circuitry, or in computer-based software, firmware, or hardware, including the structures disclosed in this specification and/or their structural equivalents, and/or in combinations thereof. In some embodiments, the subject matter disclosed herein can be implemented in one or more computer programs, that is, one or more modules of computer program instructions, encoded on computer storage medium for execution by, or to control the operation of, one or more data processing apparatuses (e.g., processors). Alternatively, or additionally, the program instructions can be encoded on an artificially generated propagated signal, for example, a machine-generated electrical, optical, or electromagnetic signal that is generated to encode information for transmission to suitable receiver apparatus for execution by a data processing apparatus. A computer storage medium can be, or can be included within, a computer-readable storage device, a computer-readable storage substrate, a random or serial access memory array or device, or a combination thereof. While a computer storage medium should not be considered to be solely a propagated signal, a computer storage medium may be a source or destination of computer program instructions encoded in an artificially generated propagated signal. The computer storage medium can also be, or be included in, one or more separate physical components or media, for example, multiple CDs, computer disks, and/or other storage devices.

Certain operations described in this specification (e.g., aspects of those represented in FIGS. 3-9 and otherwise disclosed herein) can be implemented as operations performed by a data processing apparatus (e.g., a processor/specially programmed processor/computer) on data stored on one or more computer-readable storage devices or received from other sources, such as the computer system and/or network environment described herein. The term “processor” (or the like) encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, for example, code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing, and grid computing infrastructures.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations may be described herein as occurring in a particular order or manner, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Other implementations are within the scope of the claims.

What is claimed is:

1. A computer-implemented method of characterizing geometry of a person's hand, the method comprising:
inputting a three-dimensional point cloud of the person's hand into a clustered dynamic graph convolutional neural network (clustered DGCNN);
processing the three-dimensional point cloud, with a shared network portion of the clustered DGCNN that comprises one or more convolutional layers, to create a processed version of the three-dimensional point cloud; and
with a shape regression network portion of the clustered DGCNN:
assigning each respective feature point in the processed version of the three-dimensional point cloud to a corresponding one of a plurality of pre-defined clusters, wherein each pre-defined cluster corresponds to a unique part of a hand's surface; and
applying one or more transformations to the feature points assigned to each respective cluster to produce per cluster shape parameters that represent shapes associated with portions of the person's hand that correspond to associated ones of the pre-defined clusters.

2. The computer-implemented method of claim 1, wherein processing the three-dimensional point cloud with the shared network portion of the clustered DGCNN comprises applying k-nearest neighbors to every point in the three-dimensional point cloud and aggregating a result of the k-nearest neighbors.

3. The computer-implemented method of claim 1, wherein assigning each respective feature point in the processed version of the three-dimensional point cloud to a corresponding one of the plurality of pre-defined clusters comprises:
generating a cluster assignment vector, with a shape regression network portion of the clustered DGCNN, to assign a set of probabilities to each respective one of the feature point in the processed version of the three-dimensional point cloud, wherein each assigned probability represents a likelihood that a corresponding one of the feature points belongs to a corresponding one of a plurality of pre-defined clusters; and
aggregating the features points into the pre-defined clusters based on the respective probabilities assignments represented in the generated cluster assignment vector.

4. The computer-implemented method of claim 1, further comprising, with a pose regression network portion of the clustered DGCNN:
applying a non-linear transformation to all of the feature points of the processed version of the three-dimensional point cloud to produce a plurality of transformed inputs; and
aggregating the transformed input to produce pose parameters that represent a pose of the person's hand based on the input three-dimensional point cloud.

5. The computer-implemented method of claim 1, further comprising:
producing the three-dimensional point cloud of the person's hand with a three-dimensional scanner or camera directed at the person's hand in the real-world.

6. The computer-implemented method of claim 1, wherein, prior to inputting the three-dimensional point cloud of the person's hand into the clustered DGCNN, the computer-implemented method comprises:
training the clustered DGCNN with a synthetic dataset of hand images.

7. The computer-implemented method of claim 6, further comprising:
generating the synthetic dataset of hand images using a computer-implemented hand model generator with shape and/or pose parameters as inputs to the model.

8. The computer-implemented method of claim 1, wherein the clustered DGCNN comprises:
the shared network portion that comprises one or more convolutional layers in series with one another;
a pose regression network portion that comprises a global pooling layer and one or more fully connected layers in series with one another; and
the shape regression network portion that comprises a clustered pooling layer and one or more fully connected layers connected in series with one another,
wherein the clustered DGCNN is configured such that the shared network portion produces an output that is fed into the pose regression network portion of the clustered DGCNN and the shape regression network portion of the clustered DGCNN.

9. A computer system for characterizing a visual appearance of a person's hand, the computer system comprising:
a computer processor; and
computer-based memory operatively coupled to the computer processor, wherein the computer-based memory stores computer-readable instructions that, when executed by the computer processor, cause the computer-based system to:
input a three-dimensional point cloud of the person's hand into a clustered dynamic graph convolutional neural network (clustered DGCNN);
process the three-dimensional point cloud, with a shared network portion of the clustered DGCNN that comprises one or more convolutional layers, to create a processed version of the three-dimensional point cloud; and
with a shape regression network portion of the clustered DGCNN:
assign each respective feature point in the processed version of the three-dimensional point cloud to a corresponding one of a plurality of pre-defined clusters, wherein each pre-defined cluster corresponds to a unique part of a hand's surface; and
apply one or more transformations to the feature points assigned to each respective cluster to produce per cluster shape parameters that represent shapes associated with portions of the person's hand that correspond to associated ones of the pre-defined clusters.

10. The computer system of claim 9, wherein the clustered DGCNN comprises:
the shared network portion that comprises one or more convolutional layers in series with one another;
a pose regression network portion that comprises a global pooling layer and one or more fully connected layers in series with one another; and
the shape regression network portion that comprises a clustered pooling layer and one or more fully connected layers connected in series with one another,
wherein the clustered DGCNN is configured such that the shared network portion produces an output that is fed into the pose regression network portion of the clustered DGCNN and the shape regression network portion of the clustered DGCNN.

11. A non-transitory computer readable medium having stored thereon computer-readable instructions that, when executed by a computer-based processor, cause the computer-based processor to:
input a three-dimensional point cloud of the person's hand into a clustered dynamic graph convolutional neural network (clustered DGCNN);
process the three-dimensional point cloud, with a shared network portion of the clustered DGCNN that comprises one or more convolutional layers, to create a processed version of the three-dimensional point cloud; and
with a shape regression network portion of the clustered DGCNN:
assign each respective feature point in the processed version of the three-dimensional point cloud to a corresponding one of a plurality of pre-defined clusters, wherein each pre-defined cluster corresponds to a unique part of a hand's surface; and
apply one or more transformations to the feature points assigned to each respective cluster to produce per cluster shape parameters that represent shapes associated with portions of the person's hand that correspond to associated ones of the pre-defined clusters.

12. A computer-implemented method of authenticating a person's identity, the method comprising:
capturing a three-dimensional point cloud of the person's hand with a three-dimensional scanner and inputting the three-dimensional point cloud to a clustered dynamic graph convolutional neural network (clustered DGCNN);
generating shape parameters from the three-dimensional point cloud with the clustered DGCNN, wherein the shape parameters describe each respective portion of the person's hand that corresponds with an associated one of a plurality of predefined clusters, wherein the predefined clusters correspond to unique parts of a hand's surface;
computing a similarity score by comparing the generated shape parameters associated with the person's hand to a corresponding set of shape parameters associated with an earlier scanned hand on a cluster-by-cluster basis; and
determining whether the person's hand matches the earlier scanned hand based on whether the similarity score meets or exceeds a threshold value.

13. The computer-implemented method of claim 12, further comprising:
prior to inputting the three-dimensional point cloud of the person's hand into the clustered DGCNN, the computer-implemented method comprises:
capturing a three-dimensional point cloud of the earlier scanned hand;
generating the shape parameters associated with the earlier scanned hand with the DGCNN; and
storing, in computer-based memory, the generated shape parameters associated with the earlier scanned hand.

14. The computer-implemented method of claim 13, further comprising:
designating as authorized the human whose hand was earlier scanned; and
outputting to an access control device an indication that the person whose hand was later scanned is authorized if the similarity score meets or exceeds the threshold value.

15. The computer-implemented method of claim 14, further comprising:
providing the authorized human with access to a resource with the access control device in response to the indication that the person whose hand was later scanned is authorized.

16. The computer-implemented method of claim 12 wherein computing the similarity score comprises:
for each cluster, calculating a difference between the shape parameters for the person's hand and the shape parameters for the earlier scanned hand to produce a plurality of cluster-specific similarity measures; and
combining the plurality of cluster-specific similarity measures to produce a single overall similarity measure.

17. A computer system comprising:
a computer processor; and
computer-based memory operatively coupled to the computer processor, wherein the computer-based memory stores computer-readable instructions that, when executed by the computer processor, cause the computer-based system to:
capture a three-dimensional point cloud of the person's hand with a three-dimensional scanner and inputting the three-dimensional point cloud to a clustered dynamic graph convolutional neural network (clustered DGCNN);
generate shape parameters from the three-dimensional point cloud with the clustered DGCNN, wherein the shape parameters describe each respective portion of the person's hand that corresponds with an associated one of a plurality of predefined clusters, wherein the predefined clusters correspond to unique parts of a hand's surface;
compute a similarity score by comparing the generated shape parameters associated with the person's hand to a corresponding set of shape parameters associated with an earlier scanned hand on a cluster-by-cluster basis; and
determine whether the person's hand matches the earlier scanned hand based on whether the similarity score meets or exceeds a threshold value.

18. A non-transitory computer readable medium having stored thereon computer-readable instructions that, when executed by a computer-based processor, cause the computer-based processor to:
capture a three-dimensional point cloud of the person's hand with a three-dimensional scanner and inputting the three-dimensional point cloud to a clustered dynamic graph convolutional neural network (clustered DGCNN);
generate shape parameters from the three-dimensional point cloud with the clustered DGCNN, wherein the shape parameters describe each respective portion of the person's hand that corresponds with an associated one of a plurality of predefined clusters, wherein the predefined clusters correspond to unique parts of a hand's surface;
compute a similarity score by comparing the generated shape parameters associated with the person's hand to a corresponding set of shape parameters associated with an earlier scanned hand on a cluster-by-cluster basis; and
determine whether the person's hand matches the earlier scanned hand based on whether the similarity score meets or exceeds a threshold value.

19. A computer-implemented method of training a neural network to characterizing a geometry of a person's hand, the method comprising:
generating a synthetic dataset of hand images using a computer-implemented hand model generator with shape and/or pose parameters as inputs to the model; and
training a clustered dynamic graph convolutional neural network (clustered DGCNN), in a supervised learning context, using the generated synthetic hand images as inputs and the shape and/or pose parameters as labels for the inputs together with cluster assignment regularization term, so that a clustered pooling layer of the clustered DGCNN learns how to assign each point in point clouds of the hand images to particular clusters.

20. The computer-implemented method of claim 19, wherein the DGCNN comprises:
a shared network portion that comprises one or more convolutional layers in series with one another;
a pose regression network portion that comprises a global pooling layer and one or more fully connected layers in series with one another; and
a shape regression network portion that comprises a clustered pooling layer and one or more fully connected layers connected in series with one another,
wherein the clustered DGCNN is configured such that the shared network portion produces an output that is fed into the pose regression network portion of the clustered DGCNN and the shape regression network portion of the clustered DGCNN.
